(19) United States
(12) Patent Application Publication
(10) Pub. No.: US 2022/0019213 A1
(43) Pub. Date: Jan. 20, 2022

(54) DELIVERY ROBOT

(71) Applicant: Serve Robotics Inc., Redwood City, CA (US)

(72) Inventors: Ali Haghighat Kashani, San Francisco, CA (US); Colin Janssen, Vancouver (CA); Ario Jafarzadeh, San Francisco, CA (US); Bastian Lehmann, San Francisco, CA (US); Sean Plaice, San Francisco, CA (US); Dmitry Demeshchuk, San Francisco, CA (US); Marc Greenberg, San Francisco, CA (US); Kimia Nassehi, San Francisco, CA (US); Nicholas Fischer, San Francisco, CA (US); Chace Medeiros, San Francisco, CA (US); Enger Bewza, San Francisco, CA (US); Cormac Eubanks, San Francisco, CA (US)

(21) Appl. No.: 17/309,582

(22) PCT Filed: Dec. 9, 2019
(86) PCT No.: PCT/US19/65278

§ 371 Date: Jun. 7, 2021

Related U.S. Application Data
(60) Provisional application No. 62/777,020, filed on Dec. 7, 2018.
(60) Provisional application No. 62/780,566, filed on Dec. 17, 2018.

(51) Int. Cl. G05D 1/00; B60K 1/02; B60Q 1/34; G05D 1/02; B60Q 1/44; B60R 25/20; B60R 25/01; G06K 9/00

(52) U.S. Cl. CPC G05D 1/0011; B60K 1/02; B60Q 1/34; G05D 1/0088; G05D 1/0212; H04N 7/181; B60R 25/20; B60R 25/01; G05D 1/0231; G05D 1/0276; G06K 9/00664; B60Q 1/44

(57) ABSTRACT

Described herein is a delivery robot that can be programmed to travel from one location to another in open spaces that have few restrictions on the robot's path of travel. The delivery robot may operate in an autonomous mode, a remote controlled mode, or a combination thereof. The delivery robot can include a cargo area for transporting physical items. The robot can include exterior display devices and/or lighting devices to convey information to people that the robot may be encountering, including indications of the robot's direction of travel, current status, and/or other information.

### CROSS-REFERENCES TO RELATED APPLICATIONS

This application claims benefit under 35 USC§ 119(e) to U.S. Provisional Patent Application Ser. No. 62/777,020 filed Dec. 7, 2018 and entitled “Delivery Robot”, and U.S. Provisional Patent Application Ser. No. 62/780,566 filed Dec. 17, 2018 and entitled “Delivery Robot”, disclosures of which are incorporated by reference herein in their entirety for all purposes.

### BACKGROUND

Various courier services are used to deliver goods within a short period of time. If the courier service is a human-operated vehicle, such as a car or a motorcycle, the delivery of the goods is subject to human error (e.g. picking up wrong item, delivery to a wrong recipient) and/or environmental impacts (e.g. traffic). For example, when a consumer orders food from a nearby restaurant, a courier will drive to the restaurant, wait in traffic, look for parking, and repeat the process when the courier delivers the food to the customer.

Robots can serve many functions that can improve efficiency and solve problems in situations where human effort can be better spent. For example, a robot can be built to transport physical items in areas traversed by people, and where people would otherwise be required to move the items.

A robot that travels in the same space as humans may face different challenges than, for example, a robot designed for driving among vehicles in a street. For example, the space within which the robot travels (such as a sidewalk or the interior of a building) maybe less controlled and have less defined rules of travel. Additionally, the objects moving within the space (such as people, animals, personal mobility devices such as wheelchairs, etc.) may not move in a predictable manner. People may also not be accustomed to having to share space with a robot, and thus may react negatively to the presence of a robot.

Embodiments of the invention address these and other problems individually and collectively.

### BRIEF SUMMARY

In various implementations, provided is a delivery robot configured for delivery of physical items, such as goods, food, documents, medical supplies, and so on. The delivery robot may travel in public spaces (e.g. sidewalks) to deliver a cargo to its recipient. According to various embodiments, the delivery robot may include display devices and lighting systems to notify the people nearby of its actions, or to interact with passerby pedestrians, drivers, and/or animals. The deliver robot may implement machine learning algorithms to analyze sensory input in real-time and determine an appropriate output.

Various embodiments provide a delivery robot including a chassis, a set of wheels coupled to the chassis, a motor operable to drive the set of wheel, a body mounted to the chassis, the body including a cargo area, a first lighting system including a plurality of lighting elements that can be activated in a plurality of patterns to indicate one or more of a direction of travel of the delivery robot or a current status of the delivery robot, a display device mounted on an exterior of the robot, a plurality of sensors, and a computing device comprising a processor and a memory coupled to and readable by the processor. The memory may include instructions that, when executed by the processor, cause the processor to receive input from the plurality of sensors, analyze the input from the plurality of sensors, identify an output based on the analysis, transmit the output to at least the display device for displaying on the display device, and control the first lighting system based on the analysis. Controlling the first lighting system may include activating the plurality of lighting elements in at least one of the plurality of patterns. The display device is configured to display the output received from the computing device.

Some embodiments provide a method of operating a delivery robot to move physical items in open spaces. The delivery robot includes a chassis, a set of wheels coupled to the chassis, a motor operable to drive the set of wheels, a body mounted to the chassis, the body including a cargo area, a first lighting system including a plurality of lighting elements that can be activated in a plurality of patterns to indicate one or more of a direction of travel of the delivery robot or a current status of the delivery robot, a display device mounted on an exterior of the robot, a plurality of sensors, and a computing device. The computing device receives input from the plurality of sensors, and analyzes the input from the plurality of sensors. The computing device then identifies an output based on the analysis, and transmits the output to at least the display device for displaying on the display device. The control device may control the first lighting system based on the analysis by activating the plurality of lighting elements in at least one of the plurality of patterns. The display device of the delivery robot is configured to display the output received from the computing device.

Further details regarding embodiments of the invention can be found in the Detailed Description and the Figures.

### BRIEF DESCRIPTION OF THE DRAWINGS

Illustrative examples are described in detail below with reference to the following figures:

FIGS. 1A-1F include diagrams of various views of an exemplary delivery robot;

FIGS. 2A-2C include diagrams of robot of FIG. 1A-1F that show examples of some of the internal components of the robot;

FIGS. 3A-3F include diagrams of various views of another exemplary delivery robot;

FIGS. 4A-4C include diagrams of robot of FIG. 3A-3F that show examples of some of the internal components of the robot;

FIGS. 5A-5F include diagrams of various views of another exemplary delivery robot;

FIGS. 6A-6C include diagrams of robot of FIG. 5A-5F that show examples of some of the internal components of the robot;

FIGS. 7A-7F include diagrams of various views of another exemplary delivery robot;

FIGS. 8A-8C include diagrams of robot of FIG. 7A-7F that show examples of some of the internal components of the robot;

FIG. 9A illustrates an exemplary flowchart for generating a reaction to perceived environment or states of humans, according to various embodiments;

FIG. 9B includes a diagram illustrating examples of different patterns that can be projected by the front lighting system that can be used by a delivery robot;

FIGS. 10A-10C illustrate a robot that includes a large screen incorporated into the front of the robot;

FIGS. 11A-11C include diagrams of a robot that includes two circular lighting elements mounted to the front of the robot;

FIGS. 12A-12C illustrate an example where the robot includes a large, rectangular lighting element mounted to the front of the robot;

FIG. 13 illustrates examples of graphics the robot may be able to display with a front-facing display screen;

FIGS. 14A-14B illustrate an example of a different display device that the robot can use to display the robot's current status;

FIGS. 15A-15B illustrate another display device that the robot can use to display information;

FIGS. 16A-16B illustrate an example of lighting elements the robot can use to indicate the robot's status;

FIGS. 17A-17B illustrate another lighting element that the robot can use to indicate that the robot is moving or is stopped;

FIGS. 18A-18C illustrate examples of the robot using a single lighting element to indicate the robot's status;

FIGS. 19A-19B illustrate another example of a lighting element that the robot can use to indicate the robot's current status;

FIG. 20 illustrates a robot with a lighting element that the robot can light in various patterns;

FIGS. 21A-21C illustrate one example of the robot using a large display device mounted to the front of the robot;

FIG. 22A illustrates another example of a graphic that the robot may display when about to cross a street;

FIG. 22B illustrates an example of the robot's location when the robot may display the graphic illustrated in FIG. 22A;

FIGS. 23A-23B illustrate an example where the robot includes a display screen on the front of the robot;

FIG. 24 illustrates an example of a robot using a display screen located in the front of the robot;

FIGS. 25A-25B illustrate examples of the robot using display devices to communicate with drivers while the robot crosses a street;

FIGS. 26A-26B illustrate additional examples of displays the robot can use to interact with drivers while the robot is crossing a street;

FIGS. 27A-27B illustrate examples of the robot using front-mounted lighting systems to indicate information as the robot is about to cross a street;

FIGS. 28A-28C illustrate examples of the robot using lighting systems at street crossings;

FIG. 29 illustrates another example of actions the robot can take when crossing a street;

FIG. 30 illustrates another example of the robot's use of a lighting system to indicate the robot's intention to cross a street;

FIG. 31A-31E illustrate examples of mechanisms a computing device can use to communicate with the robot;

FIG. 32 illustrates an example of an interaction between the robot and the computing device;

FIGS. 33 illustrates another example of a mechanism by which a person can verify himself or herself to the robot as the recipient for the robot's cargo;

FIGS. 34A-34B illustrate additional mechanisms by which the robot can validate a person as the intended recipient;

FIGS. 35A-35B illustrate examples of messages that the robot may be able to display with a simple array of LEDs or other light sources when interacting with a delivery recipient;

FIG. 36 illustrates another example of dynamic text that the robot can use to prompt a recipient to open the robot's cargo door;

FIG. 37 illustrates an example of an interaction a person can have with a robot when the person is expecting a delivery;

FIGS. 38A-38C illustrate examples of icons the robot can activate or display;

FIG. 39 illustrates an example of lighting elements used in conjunction with textual displays;

FIG. 40 illustrates an example of use of lighting elements to assist a delivery recipient in figuring out how to open the cargo hatch;

FIG. 41 illustrates examples of interior lights that the robot can activate when the robot's cargo area is opened by a recipient;

FIG. 42 illustrates an example of underglow or ground effect lighting;

FIG. 43 illustrates an example of information the robot an provide while underway;

FIG. 44 illustrates an example of the robot responding to hand gestures;

FIG. 45 illustrates an example of the robot interacting with a person;

FIG. 46 illustrates an example of the robot responding to abuse;

FIGS. 47A-47B illustrates images and text the robot can display on a display screen;

FIG. 48 illustrates an example of the robot requesting assistance at a street crossing;

and

FIG. 49 illustrates an exemplary flowchart of steps for moving physical items in open spaces and controlling a delivery robot to output to interact with humans.

### DETAILED DESCRIPTION

Embodiments provide a delivery robot that is adapted to transport physical items in areas traversed by people (e.g. pedestrians on sidewalks), and where people would otherwise be required to move the items. For example, the delivery robot can be configured to transport food or goods from a store to a delivery driver waiting at the curb or to the recipient of the food. As another example, the delivery robot can be configured to deliver documents from one floor in a building to another, or from one building to another. As another example, the delivery robot can be configured to carry emergency medical supplies and/or equipment, and can be programmed to drive to the scene of an emergency.

According to various embodiments, the delivery robot (“robot”) may be relatively smaller than an automobile and larger than a large dog, so that the robot does not dwarf an average-size adult, is easily visible at the human eye level, and is large enough to have a reasonable cargo area. For example, the robot may be between three to four feet tall, three to three and a half fee long, and 20 to 25 inches wide, and have a carrying capacity for items having a total volume of approximately 10,000 to 20,000 cubic inches, for example. For example, the robot may be approximately the size of a grocery store shopping car. Dimensions are provided only as examples, and the exact dimensions of the robot may vary beyond these dimensions. For example, as illustrated below, the robot may have a tower or mast attached to the top of the robot's main that extends beyond the body.

In various examples, the robot can include a body and a set of wheels that enable the robot to travel across ground surfaces, including man-made surfaces such as sidewalks or floors, and natural surfaces, such as dirt or grass. The robot can further include a first lighting system located in the front of the robot, which can be lit in various configurations to indicate different information to a person viewing the front of the robot. The robot may also include a second lighting system located in the back of the robot, and/or a third lighting system located around a portion or the entire perimeter of the robot. The robot can further include a display device positioned on, for example, a raised area or mast located on the top of the robot. In various examples, the display device can be used to communicate information to a person viewing the screen. The robot's body can further include a cargo area, or multiple cargo areas with different access points. The cargo area may be removable from the chassis of the robot. The robot can further include an onboard or internal computing device, which travels with the robot, can control the operations of the robot, and can receive instructions for the robot over wired and/or wires connections. The robot can further include internal components for power, propulsion, steering, location tracking, communication, and/or security, among other examples. For example, the robot can include rechargeable batteries and a motor. In some examples, the robot can include multiple motors, such as a motor for controlling each wheel.

In various examples, the robot may be operable in an autonomous mode to travel autonomously from a first location to a second location. For example, the robot may be programmable to travel from one geographic location to another, where the geographic locations are identified by a street address, a latitude and longitude, or in another manner. As another example, the robot may programmable to travel within a building, for example from one office in the building to another, where the robot's route may include doorways and in elevators.

Autonomous, in this context, means that, once the robot receives instructions describing a route to traverse, the robot can execute the instructions without further input from a human operator. The robot may receive the instructions from an remote computing device, such as a laptop computer, a desktop computer, a smartphone, or another type of computer. The computing device is “remote” in that the computing device is not mounted to the robot and does not travel with the robot. The remote computing device may have information such the robot's current location, destination, and possible routes between the robot's current location and the destination. The remote computing device may further have access to geographic maps, floorplans, and other physical information that the remote computing device can use to determine the robot's route.

To receive instructions, in some examples, the robot's onboard computing device can be physically connected to the remote computing device, for example using a cable. Alternatively or additionally, the onboard computing device may include a wireless networking capability, and thus may be able to receive the instructions over a Wi-Fi and/or a cellular signal. In examples where the robot has a wireless receiver, the robot may be able to receive instructions describing the robot's route while the robot is in a different location than the remote computing device (e.g., the robot is remote from the remote computing device).

Once the robot has been programmed, the robot can receive a signal to begin traversing the route to the destination. The remote computing device can send a signal to the robot's onboard computer, for example, or a human operator can press a physical button on the robot, as another example. In some examples, once the robot is in motion, the robot may be able to receive an updated route over a wireless connection, and/or may be able to request an updated route when the robot finds that the original route is impassable or when the robot loses track of its current location (e.g., the robot becomes lost).

In various examples, the robot may be operable in an remote controlled mode to travel autonomously from a first location to a second location. For example, the robot may receive instructions from a human pilot operator of the remote computer. The robot may then execute the received instructions to move along the route.

Once in motion, the robot may encounter situations that may not be explicitly provided for in the instructions describing the robot's route. For example, the instructions may include left or right turns and distances to travel between turns, or successive waypoints the robot is to reach. The instructions, however, may not explicitly describe what the robot should do should the robot encounter an obstacle somewhere along the way. The obstacle may not be noted in the data the remote computer uses to determine the robot's route, or may be a mobile obstacle, so that the obstacle's presence or location may not be predictable. In these and other examples, the robot's onboard computing device can include instructions for adjusting the robot's path as the robot travels a route. For example, when the robot's sensors indicate that an object is located within a certain distance (e.g., three feet, five feet, and/or a distance that varies with the robot's current velocity) from the front of the robot, the onboard computer can cause the robot to slow down and/or turn right or left to navigate around the object. Once the robot's sensors indicate that the obstacle has been bypassed, the onboard computer can adjust the robot's path back to the intended course, if needed.

In various examples, the robot's route may further include spaces that can be shared with people, who may be walking, running, riding bicycles, driving cars, or otherwise be ambulatory. In these examples, to assist the robot in navigating among people, the robot can include an array of sensors that can detect people or objects within a certain distance from the robot (e.g., three feet, five, or another distance). The sensors can include, for example, radar, lidar, sonar, motion sensors, pressure and/or toggle actuated sensors, touch-sensitive sensors, moisture sensors, displacement sensors (e.g. position, angle, distance, speed, acceleration detecting sensors), optical sensors, thermal sensor, and/or proximity sensors, among other examples. Using these sensors, the robot's onboard computing device may be able to determine an approximate number and an approximate proximity of objects around the robot, and possibly also the rate at which the objects are moving. The onboard computer can then use this information to adjust the robot's speed and/or direction of travel, so that the robot may be able to avoid running into people or can avoid moving faster than the flow of surrounding traffic. In these and other examples, the robot may not only be able to achieve the overall objective of traveling autonomously from one location to another, but may also be capable of the small adjustments and course corrections that people make intuitively while maneuvering among other people. In various examples, these sensors can also be used for other purposes, such as determining whether the robot has struck an object or been struck by an object.

In various examples, the robot can further include sensors and/or devices that can assist the robot in maneuvering. For example, the robot can include gyroscopic sensors to assist the robot in maintaining balance and/or a level stance. As another example, the robot can include a speedometer so that the robot can determine its speed. As another example, the robot can include a Global Positioning System (GPS) receiver so that the robot can determine its current location and possibly also the locations of waypoints or destinations. As another example, the robot can include a cellular antenna for communicating with cellular telephone networks, and/or a Wi-Fi antenna for communicating with wireless networks. In this example, the robot may be able to receive instructions and/or location information over a cellular or Wi-Fi network.

In various examples, the robot can further include other sensors to aide in the operation of the robot. For example, the robot can include an internal temperature sensors, to track information such as the temperature within the cargo area, the temperature of an onboard battery, and/or the temperature of the onboard computer, among other examples.

In various examples, the robot's body includes an enclosed cargo area that is accessible through a door, hatch, or lid. The robot may further include a locking system that can be controlled by the onboard computer. The computer-controlled locking system can ensure that the cargo area cannot be opened until the robot receives proper authorization. Authorization may be provided over a cellular or Wi-Fi connection, using Near Field Communication (NFC), and/or by entry of authorization data into an input device connected to the robot.

In some examples, the robot's body can include a secondary cargo area, which may be smaller than the primary cargo area. The secondary cargo area maybe accessible through a separate door, hatch, or lid. In some examples, the door to the secondary cargo area may be accessible from within the primary cargo area, and/or may be accessible from the exterior of the robot. In various examples, the secondary cargo area can carry items such as emergency medical supplies or equipment. This cargo can enable the robot to render aid while en route between destinations.

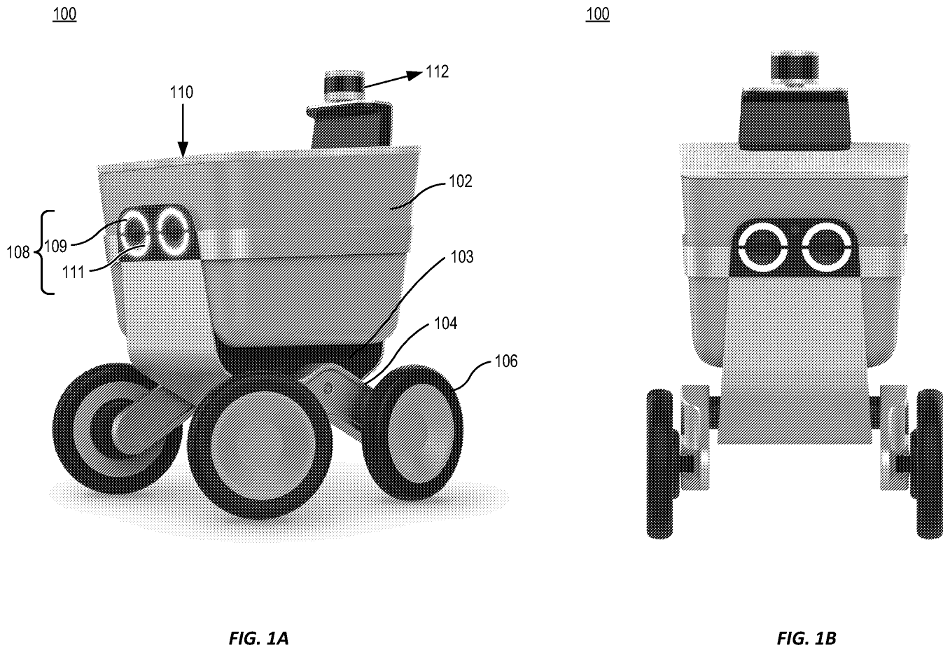

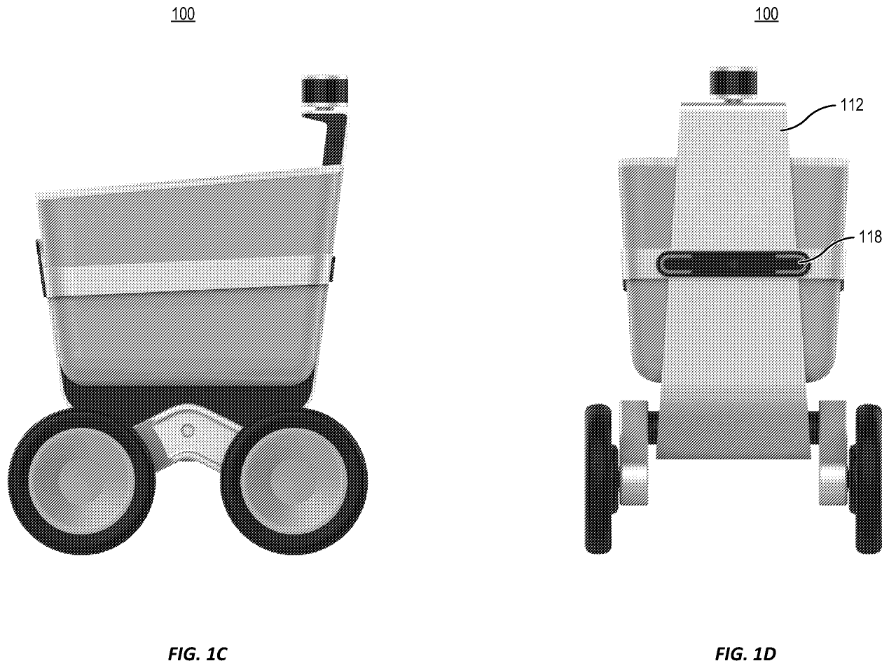

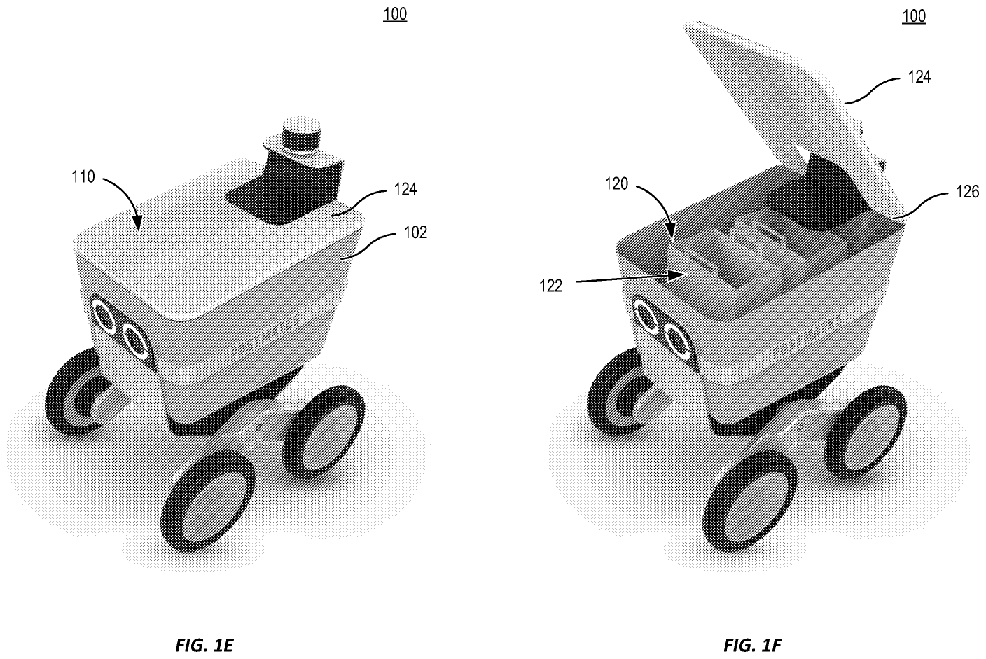

FIGS. 1A-1F include diagrams of various views of an exemplary delivery robot 100. In this example, the robot 100 includes a body 102 that is approximately rectangular, which is situated on top of a chassis 104 that includes a set of four wheels 106. In some examples, the body 102 can be removed from the chassis 104. In some examples, a motor 103 is included in the chassis 104, while in other examples, the motor 103 is included in the body 104. In this example, the robot 100 further includes a mast or tower 112 located on top of the back of the body 102.

The tower 112 can include a display screen and sensors. The robot 100 further includes lighting systems (e.g. a first lighting system 108 and a second lighting system 118) in the front and the back of the robot's body 102.

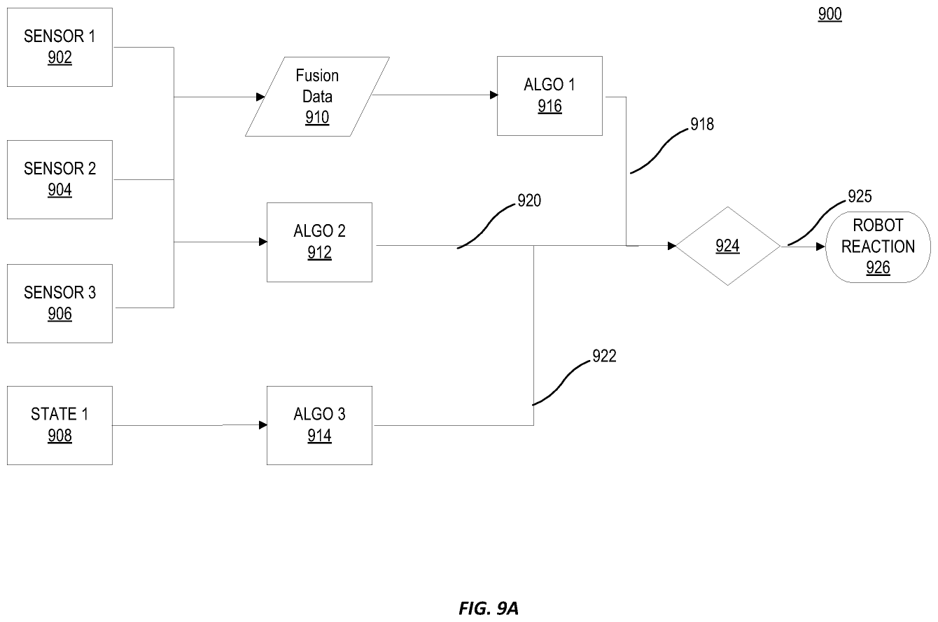

In some embodiments, the front lighting system (e.g. the first lighting system 108) may be in the shape of two circles each including include a plurality of lighting elements 109, 111 such as two half circles that can be individually controlled (further discussed below in connection with FIG. 9B). The two half circles can be illuminated using one or more LEDs, where the LEDs maybe individually controllable. In various examples, the front lighting system 108 can be activated in patterns that mimic human expressions and/or in patterns that react to human expressions. In addition, the patterns may indicate a direction of travel of the delivery robot 100, and/or a current status (e.g. busy, idle) of the delivery robot 100.

FIG. 1A illustrates a three-quarter view of the front and left side of the robot 100. FIG. 1B illustrates a view of the front of the robot 100. FIG. 1C illustrates a view of the left side of the robot 100. The right side of the robot 100 can be similar to the left side. FIG. 1D illustrates a view of the back of the robot 100, which can include a back lighting system (e.g. the second lighting system 118) incorporated into the chassis 104 or the body 102. The back lighting system can be used, for example, as brake lights to indicate that the robot is slowing down and/or stopped. FIG. 1E illustrates a three-quarter view of the front, left side, and top of the robot 100, showing the lid 124 for the cargo area 120 and the tower 112. The lid 124 may be a door enclosing the cargo area that comprises most of the top area 110 of the robot's body 102, and hinges at the back of the body 102 via coupling means (e.g. one or more hinges 126). The robot 100 may also include a locking mechanism configured to secure the door in a closed position. FIG. 1F illustrates a three-quarter view of FIG. 1E with the lid 124 open and the cargo area 120 visible. In FIG. 1F, two grocery store shopping bags as cargo 122 in the cargo area 120 are illustrated to indicate an approximate interior capacity of the cargo area 120. According to various embodiments, the cargo area 120 may be configured to carry up to 50 lbs or 75 lbs cargo.

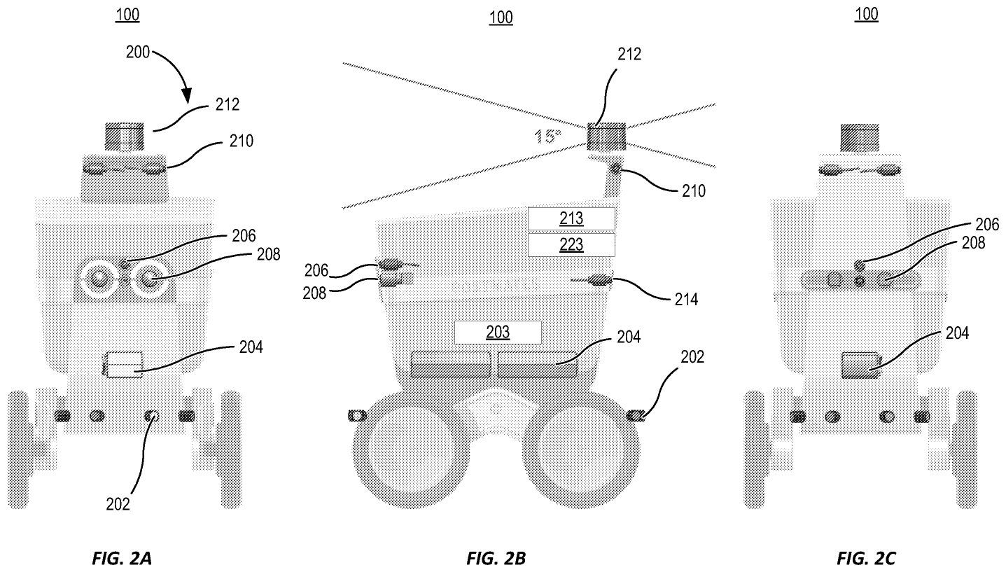

FIGS. 2A-2C include diagrams of robot 100 of FIG. 1A-1F that show examples of some of the internal components of the robot. As illustrated in FIGS. 2A-2C, the internal components can include, for example, a plurality of sensors 200 including but not limited to a lidar 212, a radar, and/or other sensors 202, 206, 210, 214 with which the robot can senses its surroundings, including building a picture of the objects that make up the environment within a certain number of feet (e.g., five, ten, fifteen, or another number of feet) around the robot. According to various embodiments, the plurality of sensors 200 include one or more cameras 208 operable to capture a view in a front direction, a side direction, or a back direction of the delivery robot 100. That is, the input from the plurality of sensors 200 identify stationary or moving objects around the delivery robot 100. The components can further include lighting systems, batteries 204, motors, and an onboard computing device 203. According to various embodiments, the locking mechanism 223 may be coupled to the computing device 203 in a wired or wireless manner. The computing device 203 may be programmed to operate the locking mechanism 223 based on one or more inputs. The robot 100 may also include one or more antennas 213 (e.g. a cellular antenna for communicating with cellular telephone networks, and/or a Wi-Fi antenna for communicating with wireless networks).

According to various embodiments, the computing device 203 may comprise a processor operatively coupled to a memory, a network interface, and a non-transitory computer-readable medium. The network interface may be configured to connect to one or more a remote server, a user device, etc. The computer-readable medium may comprise one or more non-transitory media for storage and/or transmission. Suitable media include, as examples, a random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. The “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

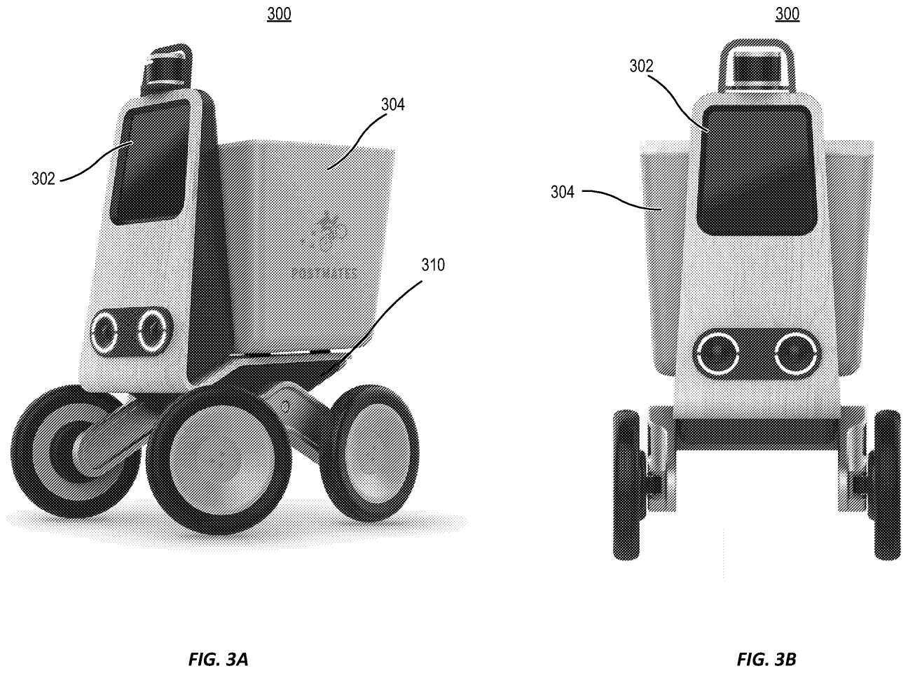

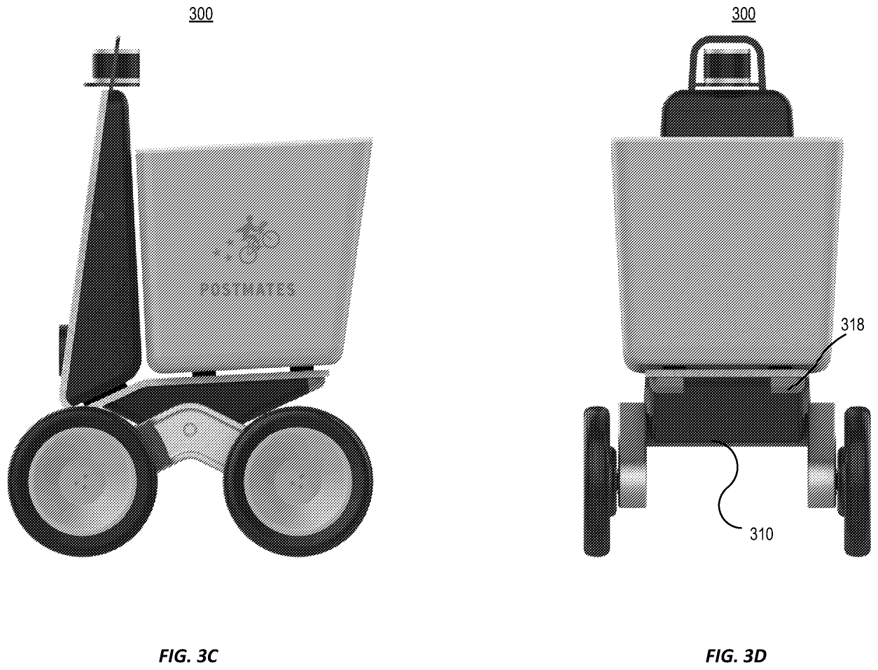

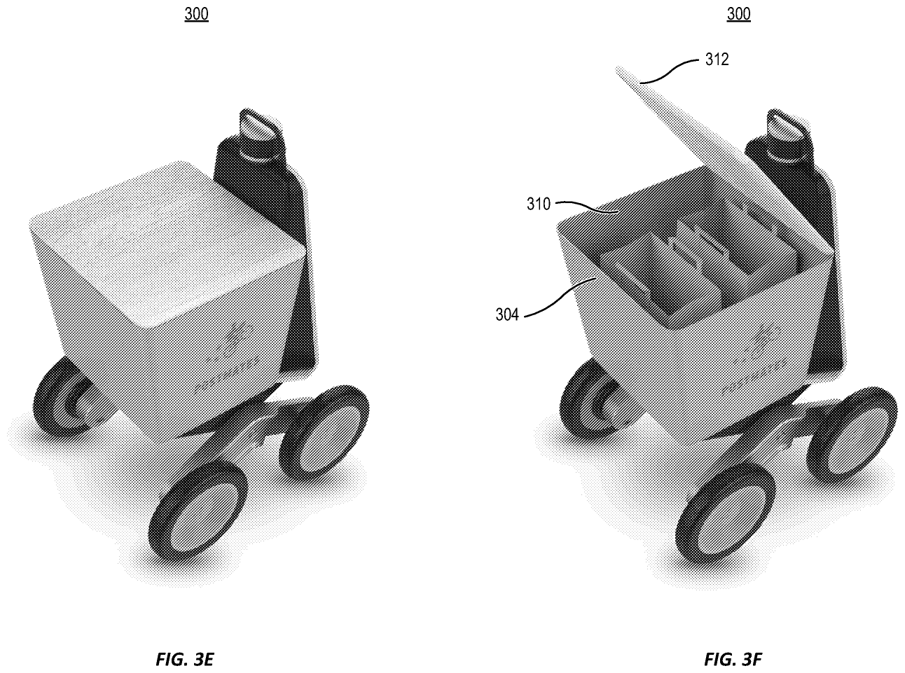

FIGS. 3A-3F include diagrams of various views of another exemplary delivery robot 300. In this example, the robot includes a body that is approximately rectangular, which is situated on top of a chassis that includes a set of four wheels. The chassis further includes a front portion that includes a lighting system, a display screen, and sensors. In this example, the front portion incorporates the mast or tower seen in other examples of the robot. In some examples, the body can be removed from the chassis. As in the previous example, the front lighting system is in the shape of two circles each including two half circles that can be individually controlled.

FIG. 3A illustrates a three-quarter view of the front and left side of another exemplary embodiment of the delivery robot 300. FIG. 3B illustrates a front view of the robot 300. FIG. 3C illustrates a view of the left side of the robot 300. The right side can be similar. As shown in FIG. 3A, the robot 300 includes a display device (e.g. display screen 302) coupled to a front panel of the robot 300. According to various embodiments, the display screen 302 may be a touch screen. The display device is configured to display an output (e.g. text and/or images) generated by a computing device (e.g. a computing device coupled to the robot 300 or a remote computing device). FIG. 3D illustrates a back view of the robot, showing the back lighting system. In this example, the back lighting system 318 is incorporated into the robot's chassis 310. FIG. 3E illustrates a three-quarter view of the top, back, and right side of the robot 300, showing the lid 312 for the cargo area 310. In this example, the lid 312 comprises most of the top area of the robot's body 304, and hinges at the front of the body 304. The robot 300 may also include a locking mechanism configured to secure the door in a closed position. FIG. 3F illustrates the three-quarter view of FIG. 3E with the lid 312 open and the cargo area 310 visible. In FIG. 3F, two grocery store shopping bags are illustrated as cargo in the cargo area 31 to indicate an approximate interior capacity of the cargo area 310.

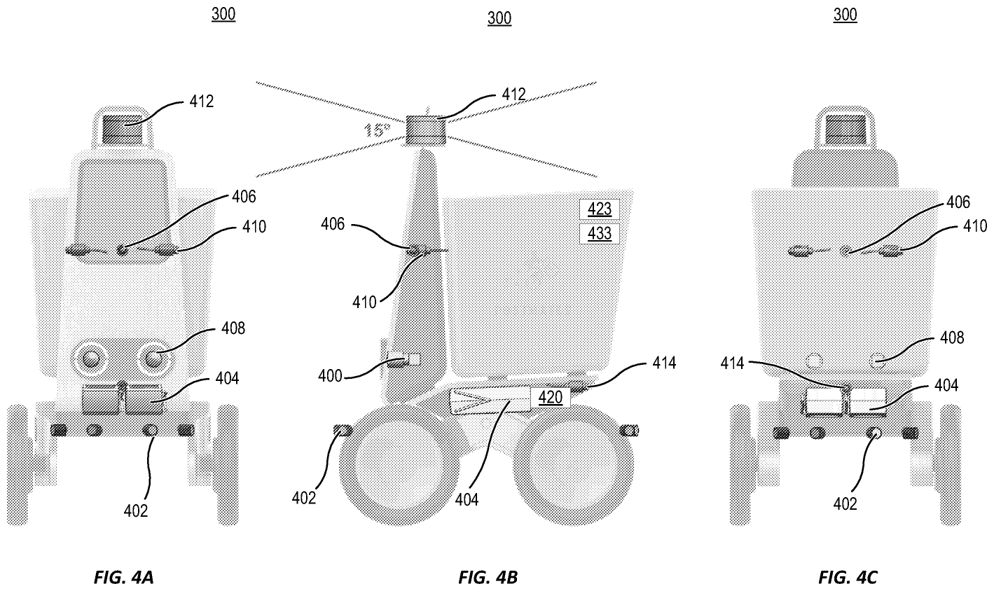

FIGS. 4A-4C include diagrams of robot 300 of FIG. 3A-3F that show examples of some of the internal components of the robot 300. As illustrated in FIGS. 4A-4C, the internal components can include a plurality of sensors, for example, a lidar 412, radar, and/or other sensors 402, 406, 408, 414 with which the delivery robot 300 can senses its surroundings, including building a picture of the objects that make up the environment within a certain number of feet (e.g., five, ten, fifteen, or another number of feet) around the delivery robot 300. According to various embodiments, the plurality of sensors include one or more cameras operable to capture a view in a front direction, a side direction, or a back direction of the delivery robot 300. That is, the input from the plurality of sensors identify stationary or moving objects around the delivery robot 300. The components can further include lighting systems, one or more rechargeable batteries 404, motors, and an onboard computing device 420. The batteries 404 may be provided in the bottom of the robot, for example into the chassis, to achieve a low center of gravity to prevent the robot from getting tipped on its side. According to various embodiments, a locking mechanism 423 may be coupled to the computing device 420 in a wired or wireless manner. The computing device 420 may be programmed to operate the locking mechanism 423 based on one or more inputs. The robot 300 may also include one or more antennas 433 (e.g. a cellular antenna for communicating with cellular telephone networks, and/or a Wi-Fi antenna for communicating with wireless networks).

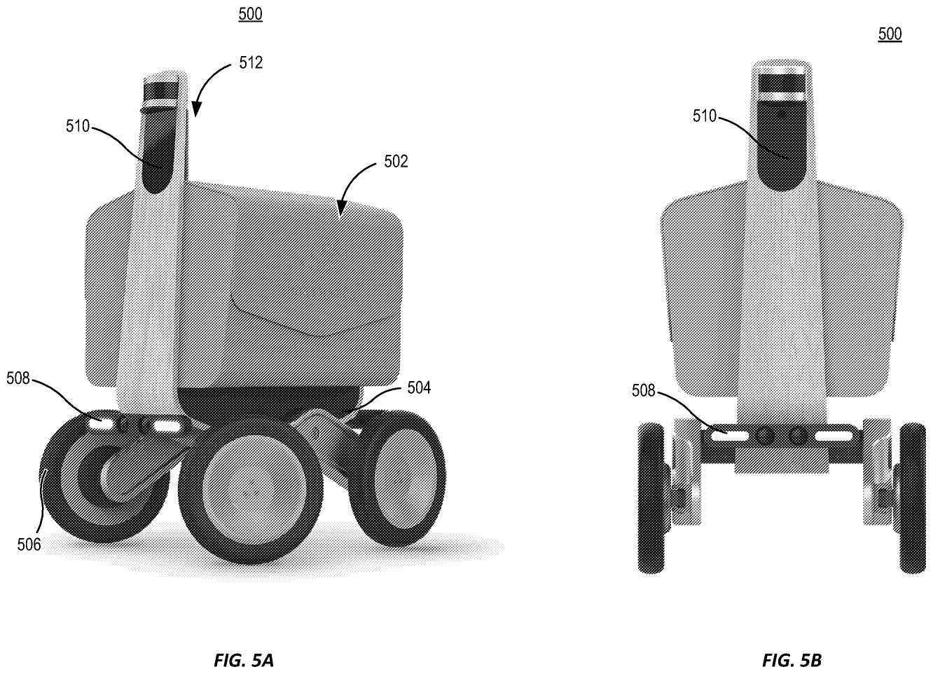

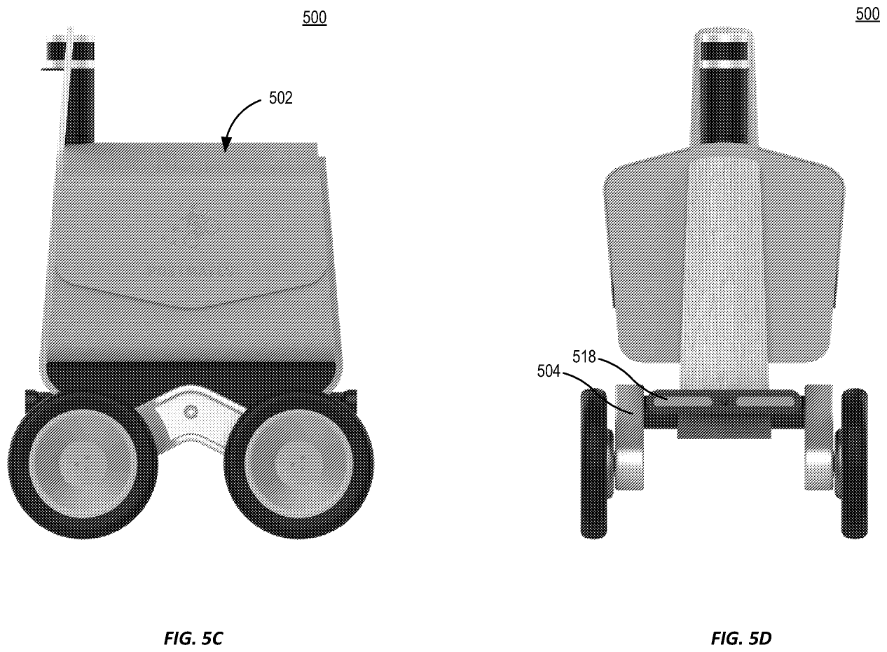

FIGS. 5A-5F include diagrams of various views of another exemplary delivery robot 500. In this example, the robot 500 includes a body 502 that is approximately rectangular, which is situated on top of a chassis 504 that includes a set of four wheels 506. The chassis 504 further includes a front portion that includes a lighting system 508, a display device (e.g. a display screen 510), and sensors. In this example, the front portion incorporates the mast or tower 512 seen in other examples of the robot. In some examples, the body 500 can be removed from the chassis 504. In this example, the robot's front lighting system 508 is mounted to the chassis 504 and includes a pair of lights that can be individually controlled. The display screen 510 can further be configured to display an output (e.g. text and/or pictures) generated by a computing device. For example, the display screen 510 can be configured to display cartoon eyes, which can be animated.

FIG. 5A illustrates a three-quarter view of the front and left side of the robot 500. FIG. 5B illustrates a front view of the robot 500. FIG. 5C illustrates a view of the left side of the robot 500. The right side can be similar. FIG. 5D illustrates a back view of the robot, showing the back lighting system 518. In this example, the back lighting system 518 is incorporated into the robot's chassis 504. FIG. 5E illustrates a three-quarter view of the top, back, and right side of the robot 500, showing a lid 514 for the cargo area 516. In this example, the lid 514 comprises part of the top and part of the side of the robot's body 502, and hinges along a longitudinal axis 520 of the top of the body 502. In some examples, the body 502 can include a similar lid on the left side of the body. FIG. 5F illustrates the three-quarter view of FIG. 5E with the lid 520 open and the cargo area 516 visible. In FIG. 5F, two grocery store shopping bags are illustrated to indicate an approximate interior capacity of the cargo area 516.

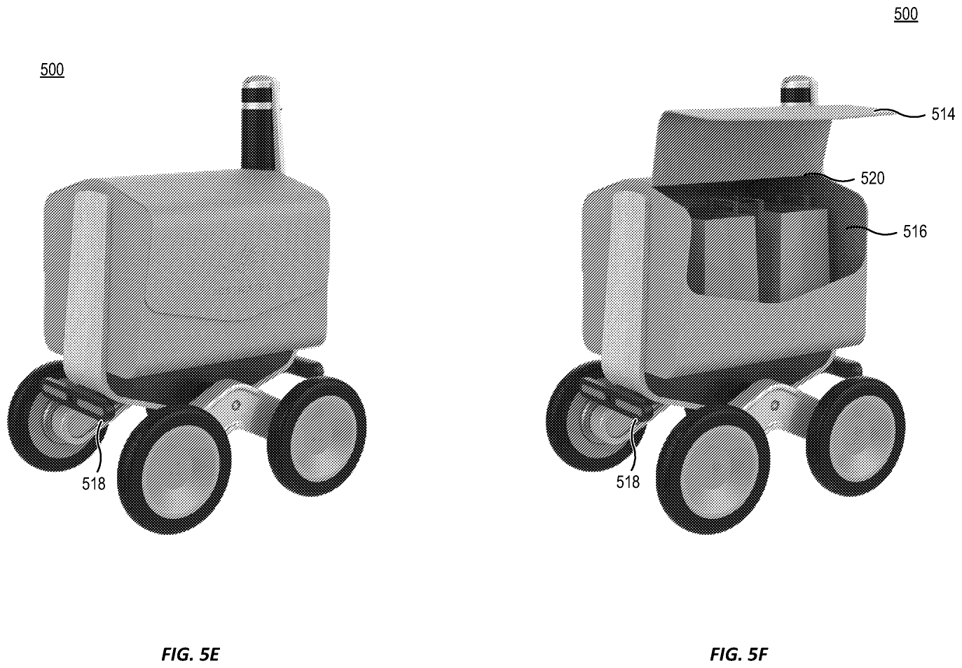

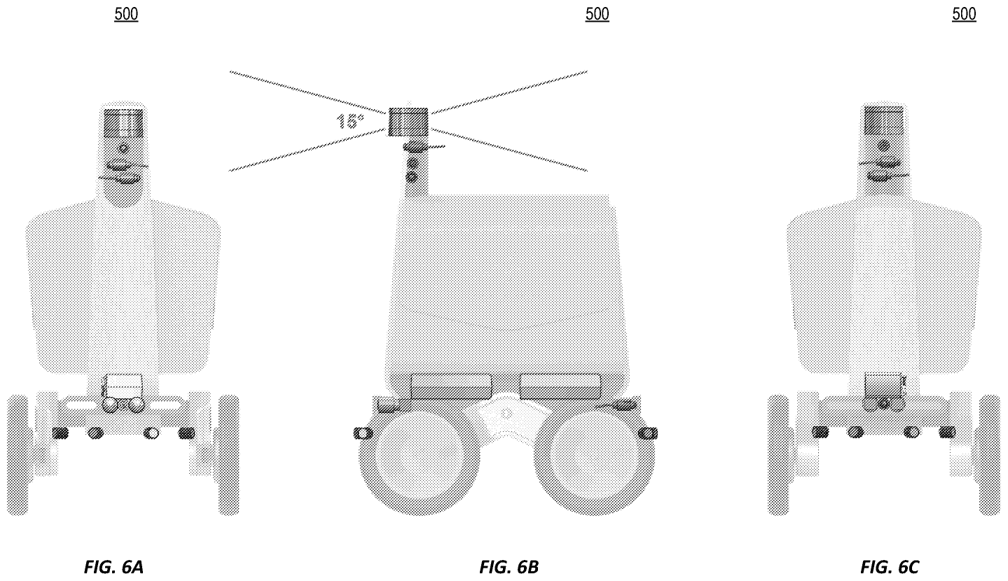

FIGS. 6A-6C include diagrams of robot of FIG. 5A-5F that show examples of some of the internal components of the robot 500. Similar to FIGS. 2A-2C, 4A-4C discussed above, FIGS. 6A-6C illustrate the internal components of the robot 500 including but not limited to a lidar, a radar, and/or other sensors with which the robot can senses its surroundings, including building a picture of the objects that make up the environment within a certain number of feet (e.g., five, ten, fifteen, or another number of feet) around the robot 500. The components can further include lighting systems, batteries, motors, and an onboard computing device.

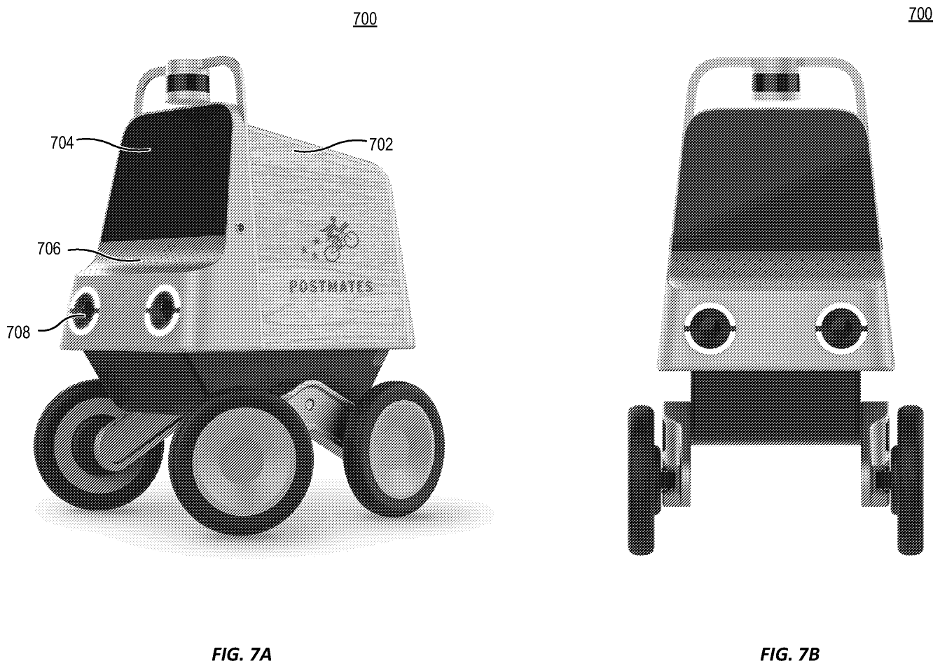

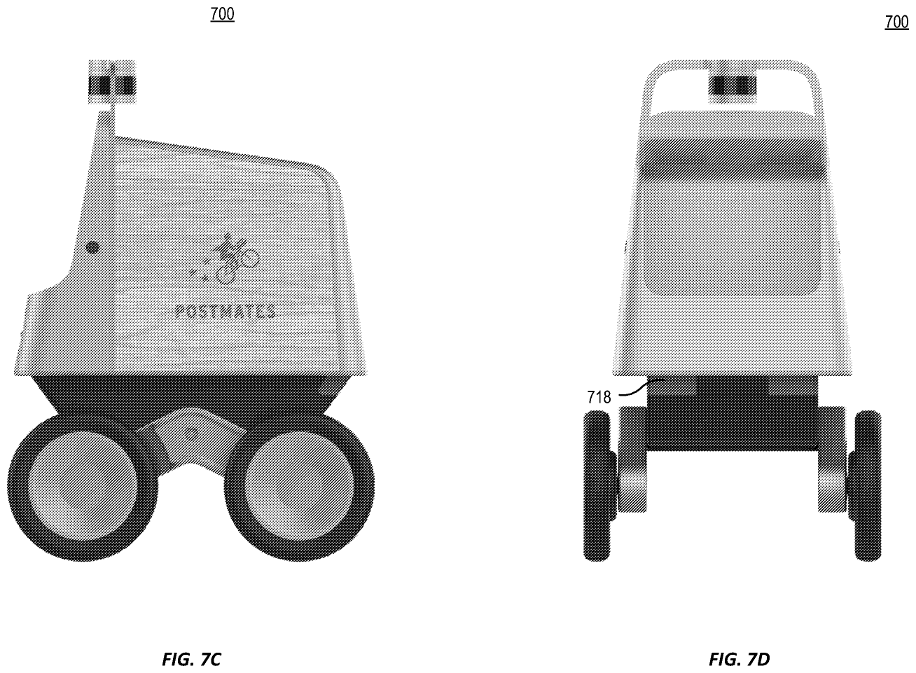

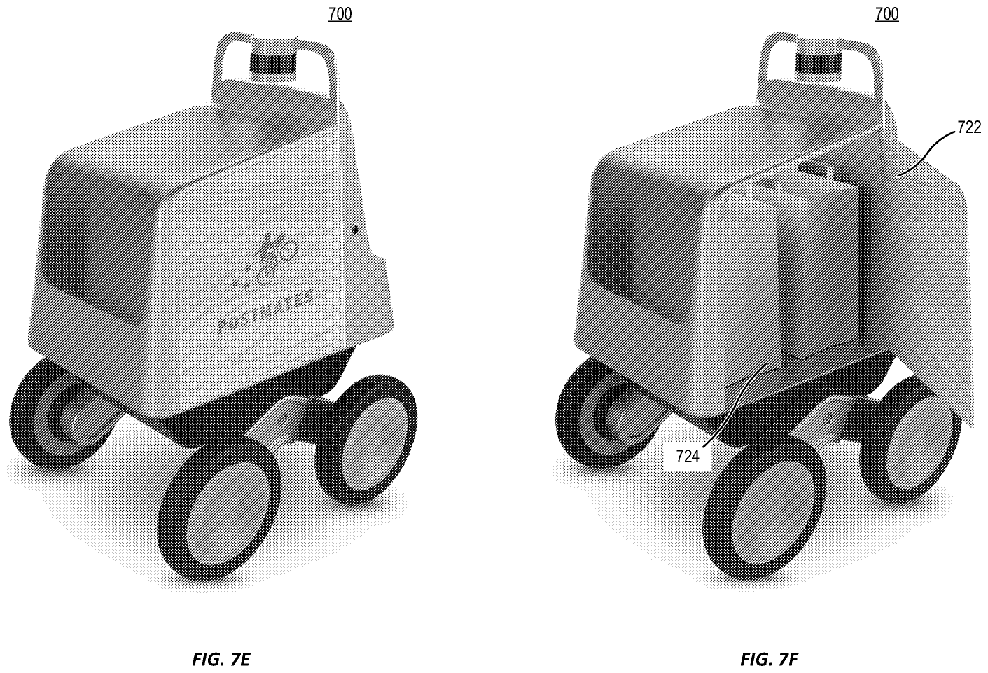

FIGS. 7A-7F include diagrams of various views of another exemplary delivery robot 700. In this example, the robot includes a body 702 that is approximately rectangular, which is situated on top of a chassis that includes a set of four wheels. The body 702 includes a front portion that incorporates the front lighting system 708, a large display screen 704, a speaker system 706 and sensors. In some examples, the body 702 can be removed from the chassis. As in the prior examples, the front lighting system 708 is in the shape of two circles each including two half circles that can be individually controlled.

FIG. 7A illustrates a three-quarter view of the front and left side of the robot 700. FIG. 7B illustrates a front view of the robot 700. As illustrated in this example, the robot's display screen 704 faces forward and includes a large portion of the front of the robot 700, and can be used to display a variety of information. FIG. 7C illustrates a view of the left side of the robot 700. The right side can be similar. FIG. 7D illustrates a back view of the robot 700, showing the back lighting system 718. In this example, the back lighting system 718 is incorporated into the robot's chassis. FIG. 7E illustrates a three-quarter view of the top, back, and right side of the robot 700, showing a door 722 for the cargo area 724. In this example, the door 722 comprises most of the right the side of the robot's body 702, and hinges along the front of the body 702. In some examples, the body 702 can include a similar door on the left side of the body. In some examples, a portion of the top and back of the body 702 can be transparent or semi-transparent, allowing visibility into the cargo area 724. FIG. 7F illustrates the three-quarter view of FIG. 7E with the door 722 open and the cargo area 724 visible. In FIG. 7F, two grocery store shopping bags are illustrated to indicate an approximate interior capacity of the cargo area 724.

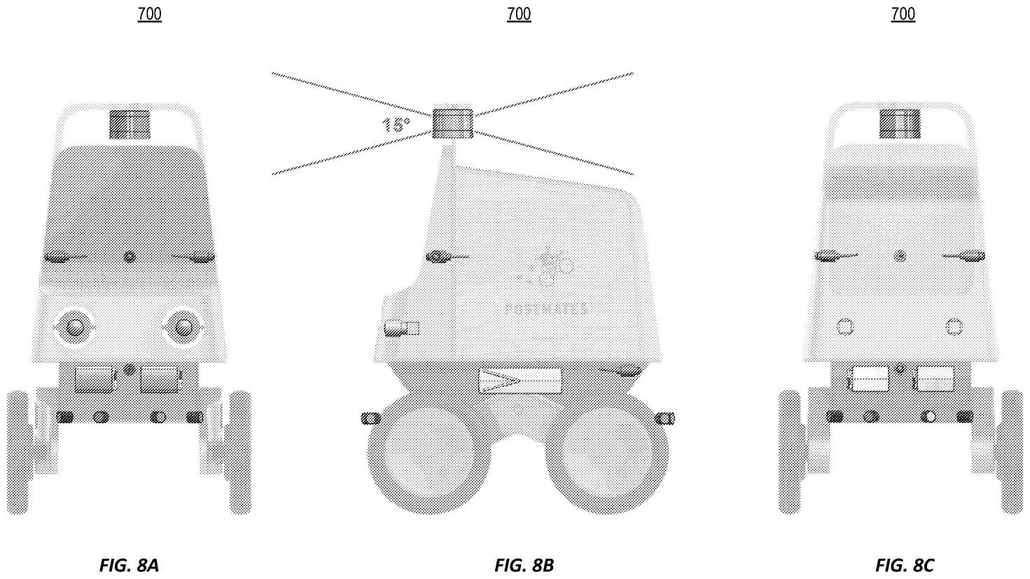

FIGS. 8A-8C include diagrams of robot of FIG. 7A-7F that show examples of some of the internal components of the robot. Similar to FIGS. 2A-2C, 4A-4C, and 6A-6C discussed above, FIGS. 8A-8C illustrate the internal components including, but not limited to a lidar, a radar, and/or other sensors with which the robot can senses its surroundings, including building a picture of the objects that make up the environment within a certain number of feet (e.g., five, ten, fifteen, or another number of feet) around the robot. The components can further include lighting systems, batteries, motors, and an onboard computing device.

In various embodiments (including those discussed above), the robot can include a computing system and a plurality of sensors including but not limited to motion detectors, cameras, and/or acoustic sensors. The sensors may provide input data to the computing system, which may then analyze the input to generate an output. In some embodiments, the robot may also include an antenna and/or transmission means to transmit the input from the plurality of sensors to a remote computer for analysis. The remote computer may analyze the input data and generate an output. The remote computer may then transmit the output to the robot for outputting using one or more of the display device, the first and/or second lighting systems, the speaker system, and the wheels. For example, the output may include a text or graphics to be displayed on the display device, a sounds to be played on the speaker system, and/or the motion instructions transmitted to the set of wheels to move wheels based on the motion instructions.

In various embodiments, the input provided by the sensors may include data associated with facial expressions or verbal/acoustic expressions of a person interacting with or in proximity of the robot. Upon analyzing the data, the computing device of the robot (or the remote computer) may generate a reaction to the person's expression(s). That is, the robot can interact with the person. In such embodiments, one or more of the display screen, the first and/or second lighting systems, the speaker system, and the wheels of the robot may be controlled to provide a human-like reaction, such as opening and closing of the “eyes” (e.g. the circular shape lights of the first lighting system), shaking of the “head” (e.g. moving the wheels right-to-left-to-right), displaying icons, emoticons, or other graphic content to show emotions, etc.

A set of predefined robot reactions may be stored in a memory of the robot. The predefined robot reactions may include one or more of the display screen displaying graphics, the first and/or second lighting systems being controlled in a variety of patterns (as illustrated in FIG. 9B), the speaker system playing sounds, and the wheels of the robot rotating to provide a human-like reaction. The memory may also store a set of rules that define one or more reactions that will be triggered conditional on the perceived environment, states of humans around the robot, and internal states of the robot.

FIG. 9A illustrates an exemplary flowchart 900 for generating a reaction to perceived environment or states of humans, according to various embodiments. As illustrated in FIG. 9A, several sensor outputs and robot internal states are provided to one or more algorithms to identify the robot reaction to trigger.

In the exemplary embodiment illustrated in FIG. 9A, the sensory data from a first sensor 902 and a second sensor 904 are fused into a fusion data 910 which is passed to a first algorithm 916 (e.g. a first computer program including for example, a machine learning software) that analyzes the fusion data 916 to generate a decision estimation 918. According to various embodiments, data fusion may vary in different sensors through extrinsic calibration, for example, projecting RGB pixels to lidar points, or project point cloud depth to RGB images. The decision estimation 918 may include a probability or confidence level for future final decision making.

Another computer program, e.g. a second algorithm 912 can take different sensory data, for example from the second sensor 904 and a third sensor 906 separately. The sensory data (e.g. data from one or more sensors) may have different modalities for the second algorithm 912 to make decisions 920 jointly on a task.

The exemplary flowchart 900 may also include a third computer program 914 may takes robot internal states as input to make a decision vote 922.

At decision block 924, the intermediate prediction results 918, 920, 922 are analyzed by a computer program to make a final decision. According to various embodiments, the analysis may be done using a machine learning algorithm such as majority voting, or probabilistic decision tree. In some embodiments, the analysis may also be performed by deep neural networks which may be supervised by a human provided decision examples. Yet in other embodiments, the analysis may be performed by reinforcement learning algorithms, which learn from the reactions (measured by sensors, as discussed below) of human pedestrians around the delivery robot and improve the decision strategy of the robot over time through experiment iterations. When the final decision is made, a final signal 925 is then sent to a behavior system which handles the execution of robot reactions 926.

The final signal 925 may include instructions that are transmitted from the computing device to one or more components of the delivery robot. For example, the instructions may be transmitted to one or more of the lighting system (for example, to control the lighting systems in one or more of predetermined patterns), the display device (for example, to control the display device to display a text or graphics), the sounding system (for example, to control the sounding system to play a sound), and/or the set of wheels (for example, to control the wheels to move based on motion instructions).

In some embodiments, the flowchart 900 illustrated in FIG. 9A may be used by the computing device of the delivery robot to receive input from the plurality of sensors, analyze the input from the plurality of sensors, identify an output based on the analysis, transmit the output to at least the display device for displaying on the display device, and control at least the first lighting system based on the analysis. The display device of the delivery robot may be configured to display the output received from the computing device.

Some of the computer programs mentioned above may be running onboard (e.g. on the computing device coupled to the delivery robot) to give low latency for applications requiring fast response. Alternatively or in addition, some of the computer programs may be running on a cloud computing infrastructure remotely to the delivery robot. The delivery robot may send the sensory input data and estimation results to the remote or cloud computer over a wireless network, if the application can tolerate some round trip latency, for example 300 ms. In some embodiments, the sensory data or intermediate results may be sent to a remote human operator, if the situation is complex and human operators will have a good judgement. Then the decision made by the human operator may transmitted back to the robot over the wireless network to be executed by the computing device of the delivery robot. For example, estimating general emotions of the people around the robot is not crucial for real-time navigation of the robot.

Accordingly, these types of analysis may be done at a remote server after the robot transmit sensory data to the remote server (or on the cloud). The remote server may then return the analysis result to the robot with a round trip latency around 300 ms. On the other hand, prediction of a human action or pose/position in the next 3 seconds may be required for real-time path planning. Such determination may be performed by the onboard computing device for the low latency. In another example, it may be necessary to estimate a situation where there is a crowd of people in front of the robot, and the robot needs to make imminent decisions. In such scenarios, the robot may analyze the sensory inputs and identify a decision autonomously or the robot may ask for help from a remote human pilot. Such estimations need to be fast and in time as it will be harder to navigate the robot out of a crowd once the robot got stuck in the crowd.

As explained above, the computing device coupled to the robot's body may receive input from the plurality of sensors of the robot. The input may include detected human expressions including body language, speech, verbal or non-verbal reactions. This sensory data may be received from the sensors such as Lidar, RGB monocular cameras, stereo cameras, infrared thermal imaging devices, with a frequency ranging from 1 Hz to 120 Hz (frame per second). The computing device may implement machine learning algorithms to identify attributes of a human body, such as 3D poses in the form of skeleton rendering, face poses in the format of a 3D bounding box with orientation of “front”, facial landmarks to indicate eyes, nose, mouth, ears, etc of a human user, gaze with eye locations and gazing directions, actions of the human body such as standing, walking, running, sitting, punching, taking a photo of the robot, human emotions such as happy, sad, aggressive, mild. The computing device may further identify a future position of the human body in a 3D coordinate system to indicate where the people are going to be in the near future. Verbal language (e.g. voice) may be used together with the imaging data of human body language to better understand the attributes mentioned above. In cases where the intention or attributes of a person cannot be determined using an onboard algorithm, the robot may transmit the sensory data to a remote server or a remote human operator to analyze.

According to various embodiments, the delivery robot be operated in one of an autonomous mode or a remote controlled mode. In the autonomous mode, the computing device onboard the delivery robot may generate instructions to direct the delivery robot to move from a first location to a second location. In the remote controlled mode, the delivery robot may transmit sensory data (e.g. data from one or more cameras) to a remote server computer over a wireless network. The remote server computer may be operated by a remote human pilot. The remote human pilot may guide the delivery robot based on the sensory input date. That is, the remote server may generate instructions (e.g. based on the remote human pilot's input) and transmit the instructions to the delivery robot. Thus, in the remote controlled mode, the delivery robot may receive instructions from the remote server to direct the delivery robot to move from the first location to the second location. According to various embodiments, the remote controlled mode can override the autonomous mode at any given time. For example, while the delivery robot is in the autonomous mode, the remote human pilot may still observe the delivery robot's movement. Thus, when the remote human pilot sees an emergency that requires intervention, the remote human pilot may override the delivery robot's autonomous mode, and may take control of the delivery robot.

According to various embodiments, the commands sent from remote human operator to the delivery robot may be in the form of a waypoint, a correction to the existing route (e.g. move closer to the wall), and/or actual motion commands (e.g. slow down, stop). The remote human operators may also trigger expressions or robot body language, sending output (e.g. voice), to the robot to help the robot traverse through the hard situations where people are around. In some embodiments, the remote human operator may also receive information regarding robot's states and future plan (e.g. a path consisting of a number of waypoints) as an augmented visualization component on the screen of the human operator. The remote human operator may monitor such information and offer commands to correct the robot's future plan.

FIG. 9B includes a diagram illustrating examples of different patterns 952, 954, 956, 958, 960, 962, 964, 966 that can be projected by the front lighting system that can be used by the exemplary delivery robots discussed above. As discussed above, in some examples, the front lighting system can include lighting elements configured into two circular elements (e.g. circles or rings) placed next to one another and aligned along a horizontal axis. Each of the two circular elements can further be divided in half along the horizontal axis, into two individually controllable arcs. In some examples, each arc can include a single light source (e.g., a curved LED or halogen bulb). In some examples, each arc can include multiple light sources, such as a string of LED bulbs evenly spaced along the arc shape.

The visual configuration of the lighting elements gives the overall effect of cartoon eyes, and by activating or deactivating the individual lighting elements in different arrangements, different expressions can be achieved, which may convey different information. According to various embodiments, a first individually controllable arc can be activated independently from a second individually controllable arc to create a human-line facial expression, such as winking, looking up, looking side-to-side, etc.

In the examples of FIG. 9B, lighting elements that are active or on are indicated with grey shading and lighting elements that are not active or off are indicated with no shading. In some examples, each of the lighting elements can be turned on and off all at once. In some examples, an arc that forms one a part of one of the “eyes” can be turned on and off in a sequential fashion, such as from left to right or from right to left. In these examples, the lighting elements can have an animated effect. For example, the robot can appear to be looking to one side or the other.

Upon the computing device onboard the robot identifies a reaction output based on the sensory input data, the computing device may control the first lighting system based on the reaction output. The controlling may include activating and deactivating the lighting elements in different patterns to indicate different information, and/or visual expressions. For example, the lighting elements of the first lighting system can be made to blink, wink, look up, look down, and/or look sideways, among other examples.

A robot as discussed above can include external device to indicate to passersby where the robot is going and/or what the robot is doing. The device is “external” in that the device is provided on an exterior body of the robot. For example, the robot can include one or more different kinds of visual display devices that can display information in the form of text, graphics, color, and/or lighting effects, among other examples. In some examples, the robot can also use sounds. In some embodiments, the external device may include a display device. In some embodiments, the display device may be substantially the same size as one surface of the delivery robot. For example, the display device may be sized and positioned to cover most of the delivery robot's front surface. According to various embodiments, the display device may display an output including, for example, a text or an image that indicates one or more of a current status of the delivery robot, a direction of travel of the delivery robot or an identification of the delivery robot to a recipient of cargo being carried by the delivery robot.

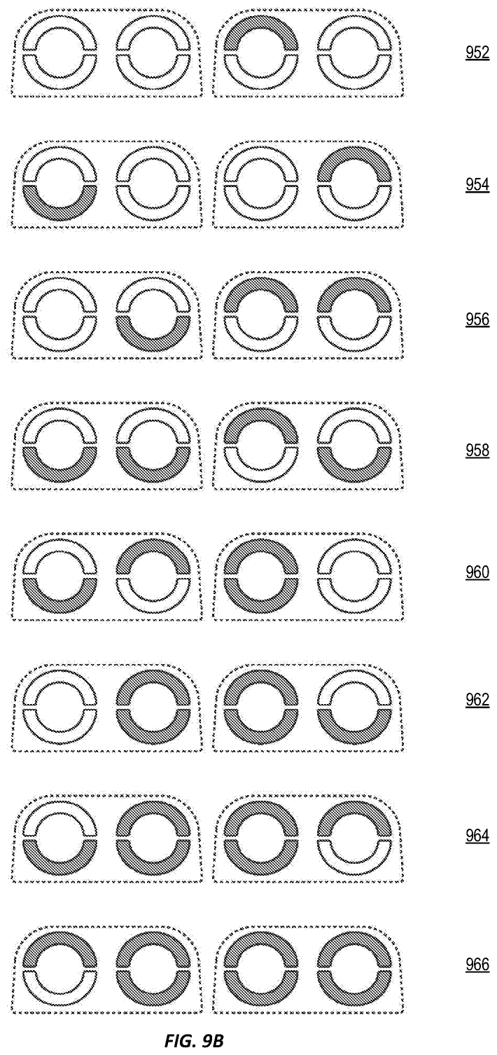

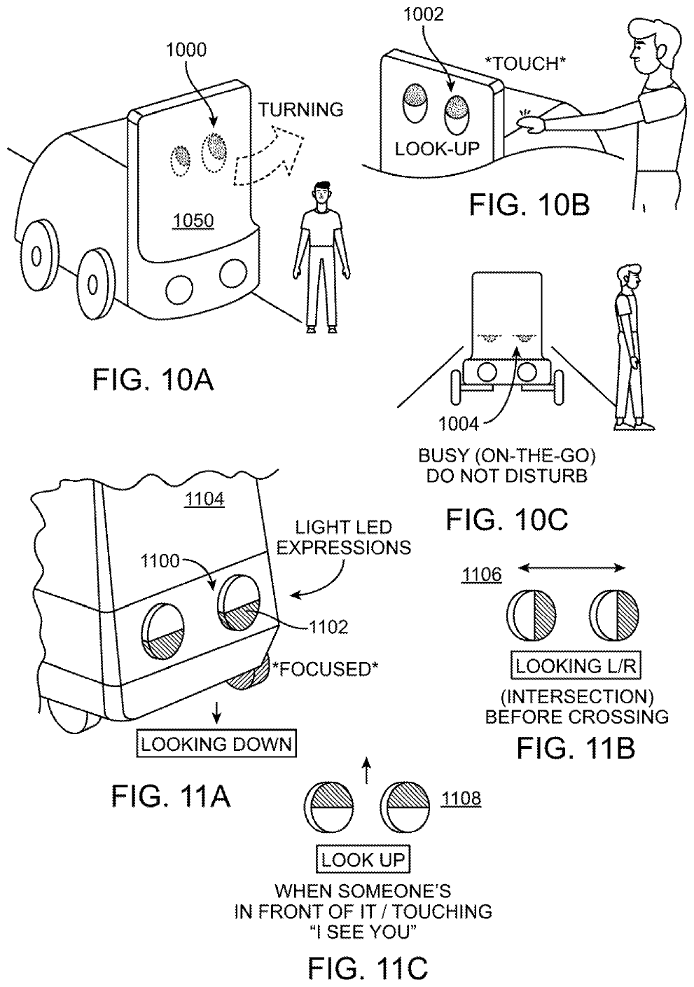

FIGS. 10A-10C illustrate a robot that includes a large display device 1050 (e.g. screen) incorporated into the front of the robot, which the robot can use to indicate what the robot is doing and/or where the robot is going. In this example, the display device can be configured to display text or graphics. The display device can be low resolution or high resolution. The display device can be monochrome, grayscale, or can display colors. When in color, the display device may be able to display a small number of colors (e.g., 8-bit color) or a wide array of colors (e.g., 16-bit or 24-bit color). The display device can be, for example, a Liquid Crystal Display (LCD) screen or an LED array, among other examples.

In FIG. 10A, the robot has configured the display device 1050 to display a pair of eyes that are looking to the left 1000, to indicate that the robot is turning or about to turn to the left. In various examples, the eyes can be animated, so that the robot's “gaze” moves from forward to the left.

In FIG. 10B, the robot has configured the display device 1050 to illustrate a pair of eyes looking up 1002, to acknowledge a person who has touched the robot. The eyes may be animated in this example, so that the robot's “gaze” moves from forward, or changes from an “eyes closed” graphic to an “eyes open” graphic, to more clearly acknowledge the person.

In FIG. 10C, the robot has configured the display device 1050 to illustrate a pair of eyes partially closed in look of concentration 1004, to indicate that the robot is busy, and should not be disturbed. The robot may configure this display while the robot is underway between destinations, for example. One of ordinary skill in the art will appreciate that the configurations provided herein are for illustration purposes, and that the display device 1050 can be configured to display any type of text and/or graphics.

The external device of the delivery robot to indicate to passersby where the robot is going and/or what the robot is doing may also include one or more lighting systems. An exemplary lighting system may include a plurality of lighting elements that may be activated in one or more of a plurality of patterns to indicate one or more of a direction of travel of the delivery robot or a current status (busy or idle) of the delivery robot.

FIGS. 11A-11C include diagrams of a delivery robot that includes a lighting system with two circular lighting elements 1100 mounted to the front of the robot, aligned along a horizontal axis. In various examples, the two lighting elements can be lit in different patterns. In the examples of FIGS. 11A-11C, the lighting patterns are circular or oval shaped, in imitation of cartoon pupils, so that the overall effect of the lighting elements is of cartoon eyes. The lighting elements can be, for example, LEDs or circular LED arrays.

In the example of FIG. 11A, the robot has configured the lighting elements 1100 in a first pattern 1104 where the “pupils” 1102 are looking down. The pupils 1102 may be flattened across the top, to give the impression that the robot's “eyes” are partially closed. In this configuration, the lighting elements 1100 can give the impression that the robot is concentrating, and should not be disturbed. The robot may use this lighting pattern when the robot is traveling between locations, for example.

FIG. 11B illustrates the lighting elements in a second pattern 1106 where the “pupils” looking to the left. In some examples, the robot may activate the lighting elements to move the “pupils” from left to right, as if the robot is looking left and right. The robot may use this configuration and pattern, for example, before crossing a street at a crosswalk, as a signal to drivers and pedestrians that the robot is about to cross the street.

FIG. 11C illustrates the lighting elements in a third pattern 1108 where the “pupils” looking up. The robot may use this configuration and pattern, for example, when interacting with a human user to indicate that the robot “sees” (i.e. is aware of) the user.

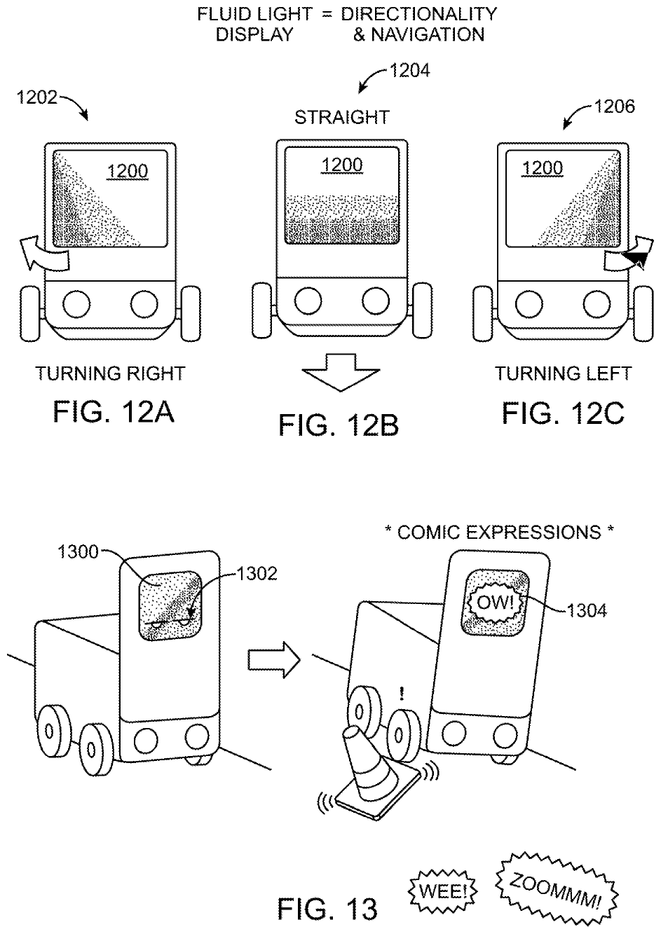

FIGS. 12A-12C illustrate an example where the robot includes a large, rectangular lighting element 1200 mounted to the front of the robot. The lighting element 1200 may be a display device, or may include an array of individually controllable lighting elements, such as LEDs. In this example, the robot can activate the lighting element 1200 in gradient patterns, as if the lighting element is a tank filled with fluid. For example, one area of the lighting element 1200 can be fully lit, an opposite area can be unlit, and the area in between can gradually transition from lit to unlit. In some examples, the robot may be able to animate the patterns display by the lighting element, so that the “fluid” appears to move from one part of the lighting element to another.

In the example of FIG. 12A, the robot has lit the lighting element 1200 in a first pattern 1202 where the “fluid” located primarily to the right and lower right corner of the lighting element. The robot may use this configuration to indicate that the robot is turning right or is about to turn right.

In FIG. 12B, the robot has lit the lighting element 1200 in a second pattern 1204 where the “fluid” located primarily at the bottom of the lighting element. The robot may use this configuration to indicate that the robot is moving forward and in a straight line.

In FIG. 12C, the robot has lit the lighting element 1200 in a third pattern 1206 where with the “fluid” located primarily to the left and lower left of the lighting element. The robot may use this configuration to indicate that the robot is turning left or is about to turn left.

As described above, the delivery robot may also include a display device that may display various graphics. FIG. 13 illustrates examples of graphics the robot may be able to display with a front-facing display screen 1300. In various examples, the graphics may be comical and/or colorful, so that the graphics can grab the attention of passersby and/or be more informative. For example, the robot can display half closed eyes in a look of concertation 1302. As another example, the robot can display onomatopoetic words surrounded by colors and graphics 1304, which can illustrate the robot's current status or can give the impression of the robot's “mood” as happy or concerned.

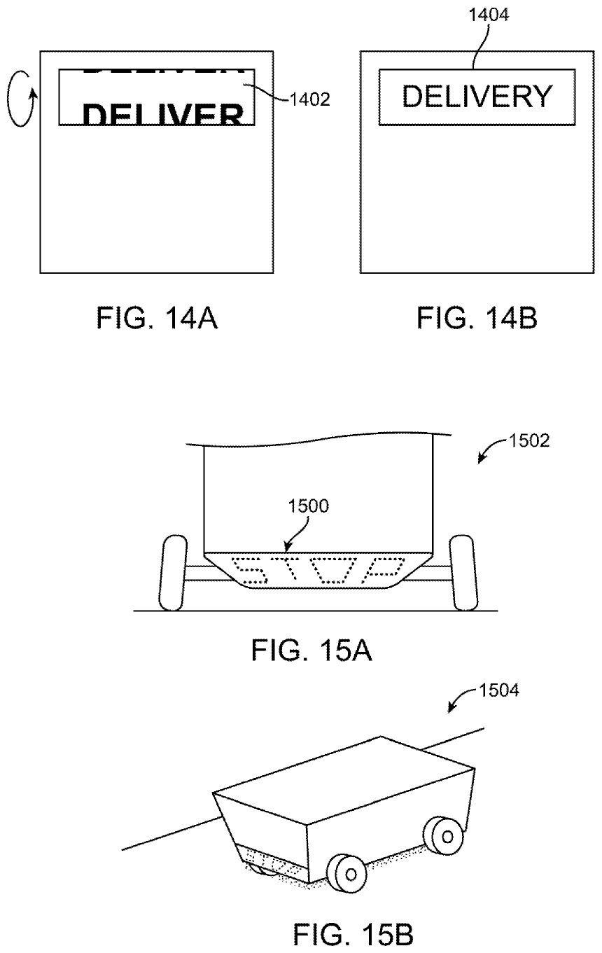

FIGS. 14A-14B illustrate an example of a different display device 1402 that the robot can use to display the robot's current status 1404. In this example, the display device 1402 displays text in a horizontal region, which may be located at the front, side, top, or back of the robot. The text can be displayed using a display screen 1402, such as an LCD or an LED array. Alternatively, the text can be printed on a drum or a roll, which can be rotated so that different text can be displayed at different times. In this case, the text may be backlit.

FIG. 14A illustrates the text being changed. The text may be animated, so that the previous text moves up and out of view and new text moves up and into view. Alternatively, as noted above, the text maybe on a drum or roll, and the appropriate text can be rolled into view.

In FIG. 14B, the robot has placed the word “Delivery” in the display, to indicate that the robot is in the process of making a deliver (e.g., traveling to a destination with cargo).

FIGS. 15A-15B illustrate another display device 1500 that the robot can use to display information. In this example, the display device 1500 is a set of lighting elements (such as LEDs) arranged in the shape of letters spelling “STOP”. In this example, the robot may activate the lighting elements to indicate that the robot is about to stop or is stopped. In various examples, the robot can include an array of lighting elements, so that the display device can be configured to display different words. In various examples, the lighting elements can be made to light up in different colors, such as red for “STOP” and green for “GO.”

FIG. 15A illustrates one location where the display device 1500 can be placed on the robot. In this example 1502, the set of lighting elements is mounted on the underside of the front or back of the robot.

FIG. 15B illustrates another location where the display device can be placed on the robot. In this example 1504, the set of lighting elements is mounted near the bottom of the front or back side of the robot.

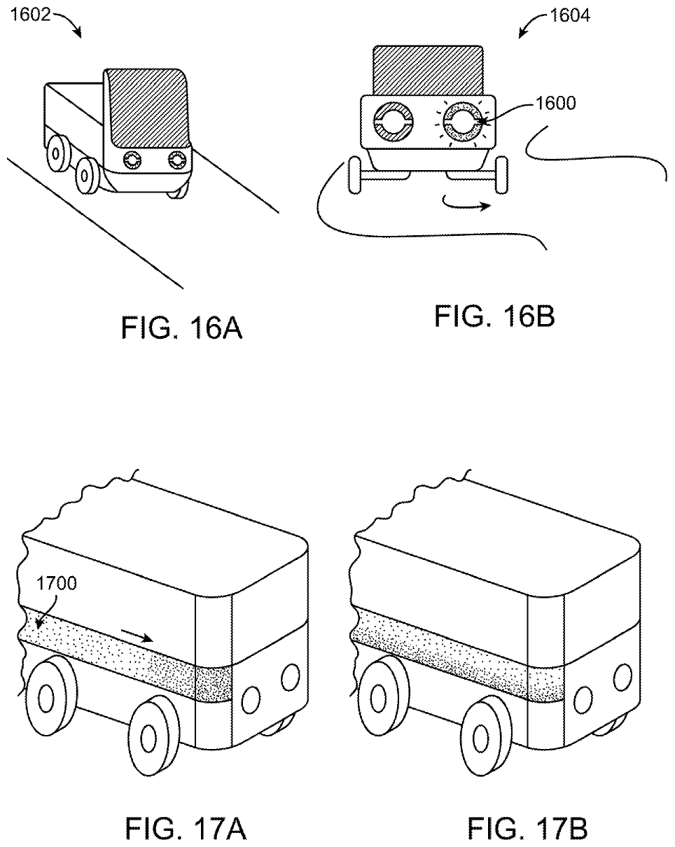

FIGS. 16A-16B illustrate an example of lighting elements 1600 the robot can use to indicate the robot's status. In this example, the lighting elements 1600 include two circles or rings mounted in the front of the robot. The rings can each be divided in half, to form two arcs.

FIG. 16A illustrates a first pattern 1602 in which the lighting elements are activated. Specifically, both of the lighting elements are activated to indicate that the robot is active and underway to a destination. When the robot is stopped and does not have a current destination, the robot may turn off the lighting elements.

FIG. 16B illustrates a second pattern 1604 in which the lighting elements are activated. Specifically, the left-hand lighting element is intermittently activated (e.g. turned on and off) in the manner of a turn signal. The robot may perform this action to indicate that the robot is about to turn left. In some examples, the robot may simultaneously turn off the right-hand lighting element, to make the turn signal indicator more clear.

FIGS. 17A-17B illustrate another lighting element 1700 that the robot can use to indicate that the robot is moving or is stopped. In this example, the robot includes a horizontal lighting element 1700 on the side of robot's body. In this example, the lighting element 1700 is illustrated on the right side of the robot. In some examples, the robot can have the lighting element on the left side of the body, or have one lighting element on each side of the body. The lighting element may include, for example, an array of LEDs.

In various examples, the robot can activate the lighting element 1700 in a gradient pattern, and/or can animate the lighting pattern illuminated by the lighting element 1700. For example, in FIG. 17A, the robot has activated the lighting element 1700 primarily towards the front of the robot, to indicate that the robot is moving forward. In this example, the robot may activate the lighting element 1700 in a repeating back-to-front pattern, to further emphasize the robot's forward motion.

In FIG. 17B, the robot has activate the lighting element 1700 to be on primarily along the bottom of the lighting element 1700. This lighting pattern may further be stationary. The robot may use this lighting pattern to indicate that the robot is stopped. When the robot begins the move, the robot may animate the lighting pattern illuminated by the lighting element 1700, for example by moving the light portion from the bottom location to the forward location.

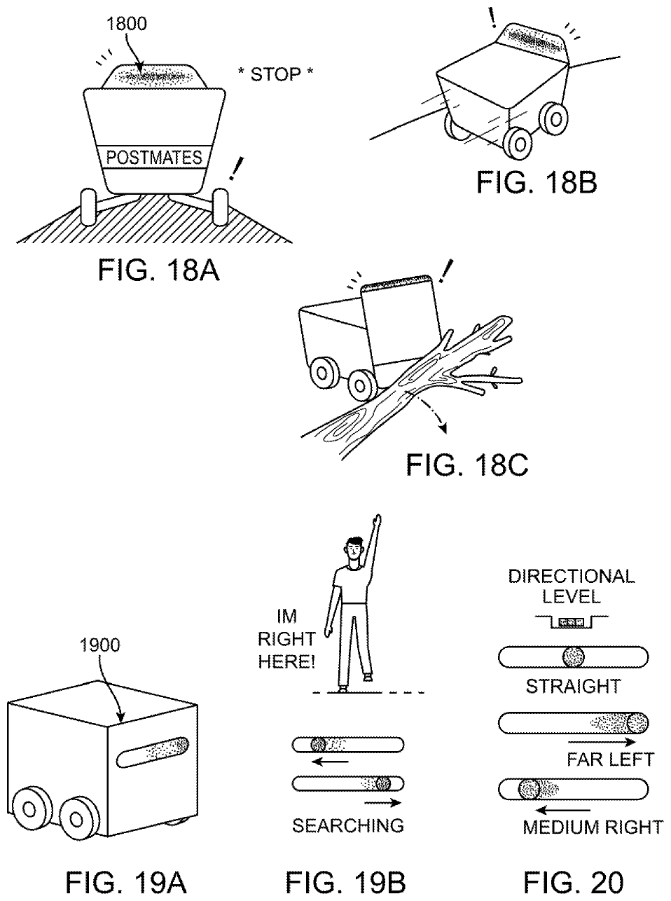

FIGS. 18A-18C illustrate examples of the robot using a single lighting element 1800 to indicate the robot's status. In these examples, the lighting element 1800 is in the shape of a bar that is positioned at the top or near the top of the robot. In various examples, the lighting element 1800 can be lit in different colors.

In FIG. 18A, the robot has lit the lighting element 1800 to indicate that the robot is stopped. The robot can, for example, activate the lighting element 1800 in a red color to indicate that the robot is stopped. When the robot is moving, the robot can activate the lighting element 1800 in a green color, for example. When the robot is crossing a street, the robot can activate the lighting element 1800 in yellow, for example, to indicate that the robot is yielding to traffic.

In FIG. 18B, the robot has configured the lighting element 1800 to flash (e.g., turn on and off rapid in succession). The robot may use this lighting pattern to indicate that the robot has come to a sudden and sudden and possibly unexpected stop. The robot may use a similar pattern when the robot encounters an unexpected obstacle, and/or runs into an object, as illustrated in FIG. 18C.

FIGS. 19A-19B illustrate another example of a lighting element 1900 that the robot can use to indicate the robot's current status. In this example, the lighting element 1900 is in the shape of a horizontal bar located in the front of the robot, as is illustrated in FIG. 19A. The robot may be able to activate a point along the lighting element 1900 in various patterns, such as a scrolling left-to-right pattern. The lighting element 1900 may include multiple light sources that can be individually activated to achieve this and other patterns, or the lighting element 1900 may include a single light source that can be activated at different intensities, at the same time, along its length. As another example, the lighting element 1900 may include a single light source that can be physically moved, (e.g., a long a track or using a pivotable bar) between the left side and the right side of the lighting element.

In various examples, the robot can activate the lighting element 1900 in the left-to-right pattern in a repeated manner to indicate that the robot is searching for something, as illustrated in FIG. 19B. The robot may be searching, for example, for a delivery recipient. In this and other examples, the robot may light the lighting element 1900 in red.

In various examples, the robot can light the lighting element in various patterns. As illustrated in FIG. 20, the robot can activate a single point in the center of the lighting element, to indicate that the robot is moving straight ahead. As another example, the robot can activate a single point to the far left. to indicate that the robot is turning left. As another example, the robot can activate a point partially and not completely to the right, which may indicate that the robot is about to turn right.

At various times, the robot may need to cross a street. In this situation, the robot may need to indicate the robot's intention to cross to people driving cars and/or to pedestrians who are also crossing the street. In various examples, the robot can use display devices and/or lighting elements to communicate with drivers and/or pedestrians.

As described above, the delivery robot may include a display device that is configured to display an output received from the computing device. In some embodiments, the display device may be substantially the same size as one surface of the delivery robot. For example, the display device may be sized and positioned to cover most of the delivery robot's front surface. According to various embodiments, the display device may display an output including, for example, a text or an image that indicates one or more of a current status of the delivery robot, a direction of travel of the delivery robot or an identification of the delivery robot to a recipient of cargo being carried by the delivery robot.

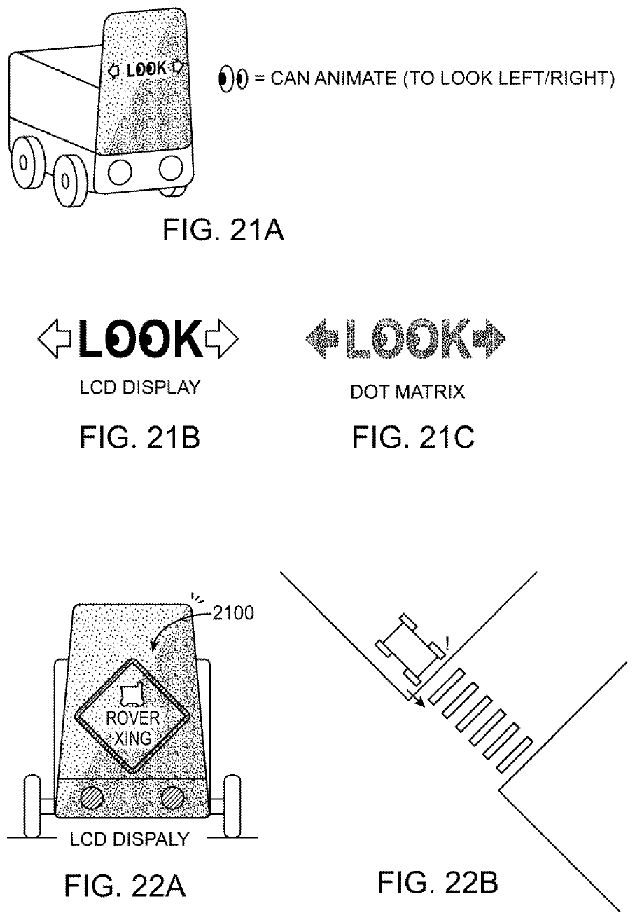

FIGS. 21A-21C illustrate one example of the robot using a large display device 2100 mounted to the front of the robot to display graphics and text to communicate that the robot is about to cross a street. As illustrated in FIG. 21A, the display device 2100 can include a screen that the robot can configure to display text and/or graphics. In this example, the text includes the word “LOOK” to indicate that the robot is looking left and right, as a person would do before crossing a street. The text is further enhances by arrows pointing left and right, and spots placed in the o's of “LOOK,” so that the o's look like cartoon eyes. In some examples, the robot may be able to animate the spots, and move the spots back and forth, to give the impression that the robot is looking from left to right and back. In some examples, robot may animate the entire graphic, moving the graphic from left to right, or may animate parts of the graphic, such as the arrows.

The display device 2100 can use different technologies to achieve the text, graphics, and/or animations. FIG. 21A illustrates an example of the graphic as the graphic would appear when the display device 2100 is an LCD display. FIG. 21B illustrates an example of the appearance of the graphic when the display device uses an array of LEDs.

FIG. 22A illustrates another example of a graphic that the robot may display on the display device 2100 when about to cross a street. In this example, the graphic is in the style of a street sign. The robot can include an LCD screen to be able to display this graphic. FIG. 22B illustrates an example of the robot's location when the robot may display the graphic illustrated in FIG. 22A. As illustrated in FIG. 22B, the robot may reach at a corner where a crosswalk is located, and may stop or pause while the robot verifies that the street is clear. While pausing, the robot can display a graphic, such as the graphic illustrated in FIG. 22A or other graphics described herein.

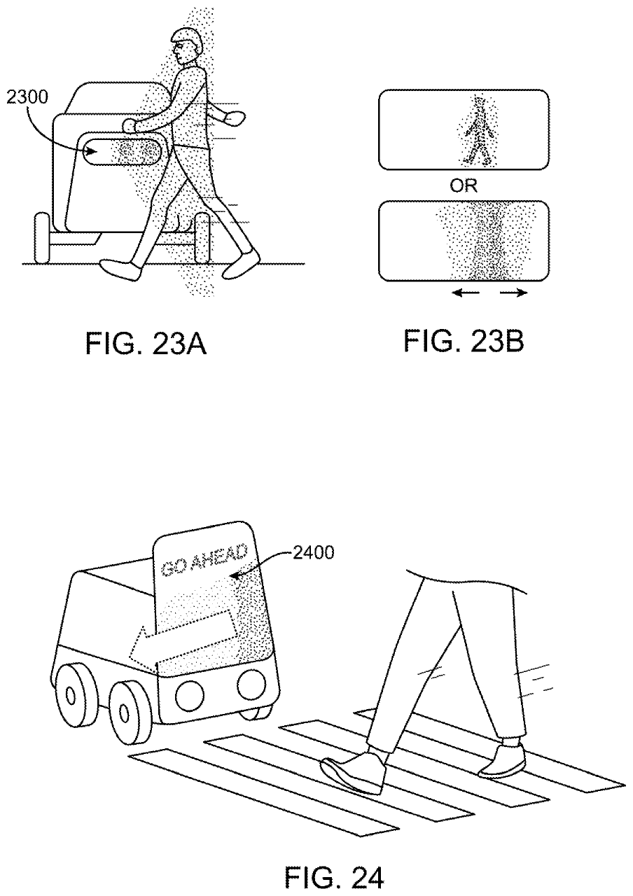

According to some embodiments, the delivery robot may display graphics on the display device that corresponds to a graphical representation of an object detected around the delivery robot. For example, on some occasion, the robot may cross paths with a person. When this occurs, the robot may display graphics that indicate to the person that the robot is aware that the person is present. FIGS. 23A-23B illustrate an example where the robot includes a display device 2300 on the front of the robot. As illustrated in FIG. 23A, the robot may be able to detect and track a pedestrian walking past the front of the robot. Using the display device 2300, the robot can display a graphic that follows the movement of the person, mimicking, for example, the manner in which a person's eyes would follow the pedestrian. FIG. 23B illustrates examples of the graphics that the robot can display on the display device 2300. The graphic can be approximately in the shape of the person, to indicate more clearly that the robot has detected the person. Alternatively the graphic can be more vague, and only indicate the approximate location of the person. In these and other examples, the graphic may move in time with the person as the person moves in front of the robot.

In various examples, the robot can use a combination of text and graphics to indicate to a person walking (or running, or riding a bicycle, wheelchair, scooter, skateboard, etc.) past the robot that the robot is yielding to the person. In FIG. 24, the robot is using a display device 2400 located in the front of the robot to display the text “GO AHEAD,” as an acknowledgement that the robot is waiting for the person to pass. The robot can further display an arrow, which may be animated, to indicate that the robot understands which direction the person is going.

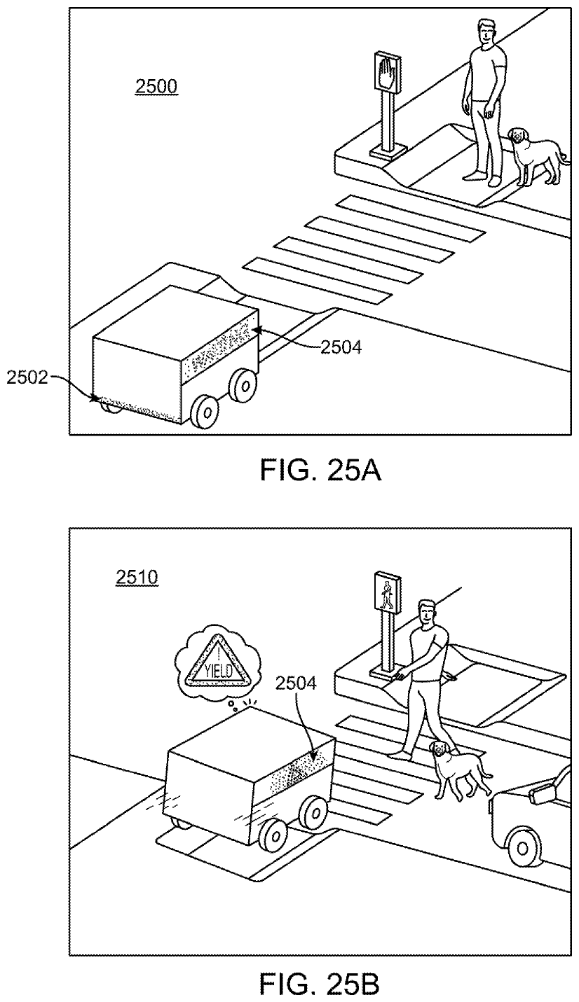

FIGS. 25A-25B illustrate examples of the robot using display devices to communicate with drivers while the robot crosses a street. FIG. 25A illustrates an exemplary state 2500 where the robot waiting at the curb for the crossing signal to indicate that the robot can cross. The robot can include a back lighting system 2502, which may be lit, in this situation, in red to indicate that the robot is stopped. The robot can further include external systems 2504 (e.g. display devices or lighting systems) on either the side of the robot's body and facing cars that may be driving across the crosswalk. While the robot is waiting at the curb, the display device can display the text “WAITING” in large letters, to indicate to drivers that the robot is waiting to cross.

FIG. 25B illustrates another exemplary state 2510 where the robot in the act of crossing the street. In this illustration, the robot has configured the display device 2504 on the side of the robot to display a yield symbol. This graphic can inform drivers that the robot is proceeding across the crosswalk, and that the drivers need to wait for the robot to cross.

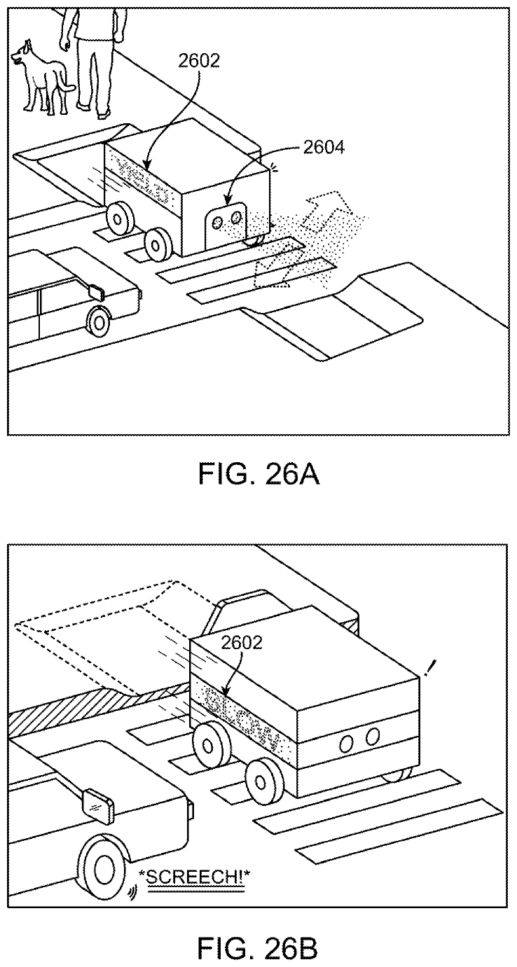

FIGS. 26A-26B illustrate additional examples of displays the robot can use to interact with drivers while the robot is crossing a street. In these examples, the robot can include external systems (e.g. a display device or lighting system) on either side of the robot's body, facing oncoming traffic. in FIG. 26A, the robot has configured the display device 2602 with the text “YIELD” to indicate to drivers that the robot is crossing, and that the drivers needs to wait. The robot is also illustrated as having a front lighting system 2604, and sweeping, from left to right and back, the direction in which the front lighting system projects light. In this way, the front lighting system 2604 can convey to pedestrians and drivers that the robot is paying attention to its surroundings. The front lighting system 2604 can also further attract the attention of drivers.

In FIG. 26B, the robot has detected that a car is approaching the crosswalk. In this example, the driver may not have seen the robot, or may not have understood the robot's display. When the robot detects that a car is moving towards the robot, the robot can change the display device 2602 on the robot's side facing the incoming car to display a different graphic (E.g. “SLOW,”) possibly flashing the words to catch the driver's attention.

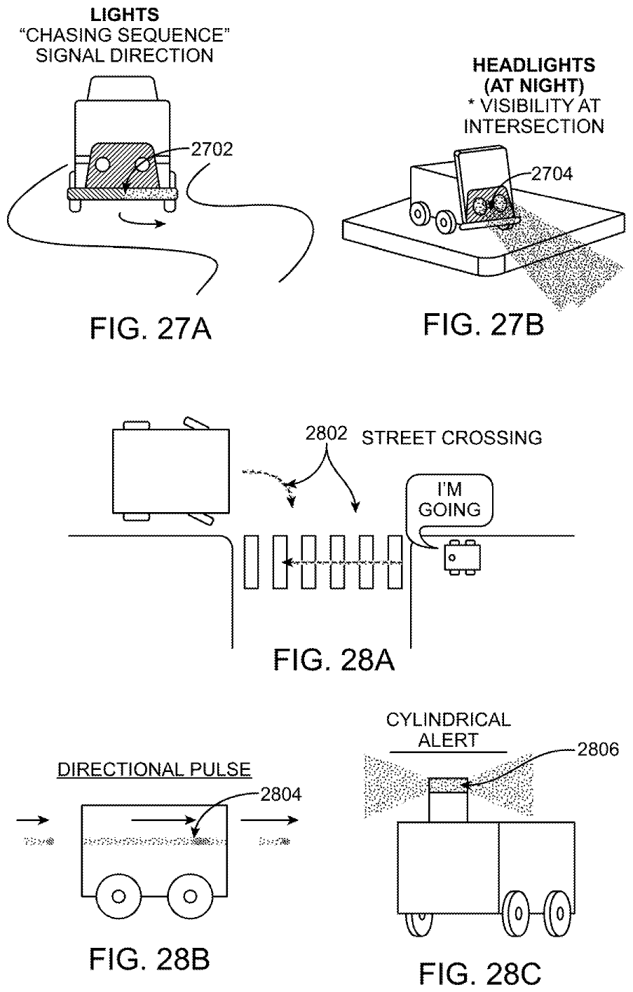

FIGS. 27A-27B illustrate examples of the robot using front-mounted lighting systems to indicate information as the robot is about to cross a street. In FIG. 27A, the robot includes a horizontal lighting element 2702 that the robot can light in, for example, a right-to-left pattern. This pattern can act as a turn signal, to indicate to pedestrians and drivers that the robot is about to turn left. FIG. 27B illustrates the robot as having a set of headlights 2704, similar to a car. In some examples, the robot may keep the headlights dim until the robot reaches a crosswalk. The robot may then increase the intensity of the headlights so that the robot is more visible to passing cars.

FIGS. 28A-28C illustrate examples of the robot using lighting systems at street crossings. In FIG. 28A, the robot can project a strong illumination 2802 across a street using a first lighting system, to get the attention of drivers and to communicate the robot's intention to cross the street. As illustrated in FIG. 28B, the robot can, alternatively or additionally, have a second lighting system 2804 on the sides of the robot's body that pulse in a back to front manner, to indicate the robot's direction and to get the attention of drivers. As illustrated in FIG. 28C, the robot can, alternatively or additionally, have a strobe light 2806 mounted high on the robot's body, to gain the attention of drivers.

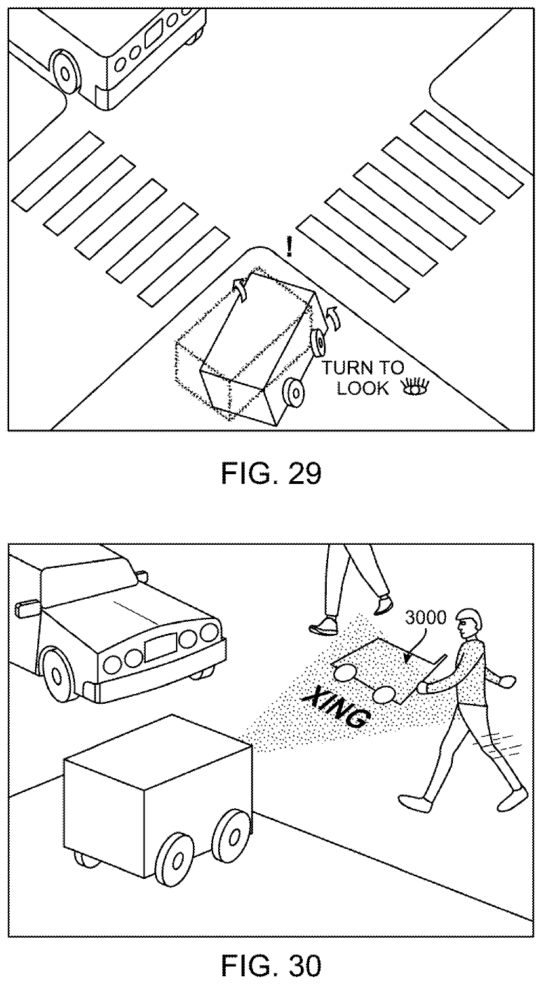

FIG. 29 illustrates another example of actions the robot can take when crossing a street. In this example, the robot can physically rotate from left to right, to mimic the behavior of a person that is about to cross the street.

FIG. 30 illustrates another example of the robot's use of a lighting system to indicate the robot's intention to cross a street. In this example, the robot has projected an image 3000 onto the ground in front of the robot. The image includes a graphic and text that indicate that the robot is about to cross.

As discussed above, the robot can transport physical items from one location to another. In some examples, a person (e.g. a recipient) is to receive the items at the robot's destination. In these examples, the robot may be able to communicate with a user device (e.g. a computing device), which the person can use to indicate that the person is the intended recipient for the items. The user device can be, for example, a laptop computer, a tablet computer, a smartphone, a smartwatch, or another type of computing device. For example, the delivery robot (e.g. the computing device of the delivery robot) may transmit a message (e.g. an e-mail, a text message) to a user device of the recipient when the computing device determines that the delivery robot has arrived at the destination. According to various embodiments, the computing device of the delivery robot may validate the recipient of the cargo being carried by the delivery robot before activating the locking mechanism to unlock the door of the deliver robot. For example, the recipient may tap, scan, wave or otherwise put the user device in close proximity of the delivery robot to establish a short-range communication (e.g. via Bluetooth®) with the delivery robot. The user device may transmit identifying information to the delivery robot. Upon validating the recipient of the cargo, the deliver robot may open the door. In some embodiments, the robot may then determine, using one or more of the plurality of sensors, that the cargo has been removed from the cargo area. The delivery robot may then close and/or lock the door.

The delivery robot may also ensure that a correct cargo is loaded in the cargo area. For example, sensor in or around the cargo area may determine properties of the cargo such as the weight, the dimensions, the heat map, etc. of the cargo within the cargo area. The sensory data may then be compared to the properties of the expected cargo. In the event of a mismatch, the robot may output a warning.

According to various embodiments, data from the onboard sensors (time-of-flight stereo cameras, RGB cameras, thermal sensors) is collected and analyzed in real-time with the onboard computing device. After the sender loaded the cargo in the cargo area of the robot and the lid is closed, a computer program is set to analyze the data from all the onboard sensors to determine, for example, (1) whether a cargo is loaded, and/or (2) the type of cargo (e.g. pizza, drinks, documents). The computer program may then compare the information for the intended cargo (e.g. provided from a remote server) to detected information to determine if the cargo is correct.

According to various embodiments, the delivery robot may also determine whether the correct cargo has been off-loaded. For example, after the robot arrives at the intended recipient, the lid is unlocked and opened by the intended recipient, and the lid is closed again. The computer program may then collect and analyze sensory data about the content of the cargo area to determine if the items are off-loaded correctly.

The delivery robot may use machine learning algorithms to analyze the sensory data to estimate what items are in the cargo area. An exemplary machine learning algorithm may include a convolutional neural network trained with human labeled data to estimate locations and classes of items in the cargo are with 3D bounding boxes in the 3D coordinate system inside the cargo area.

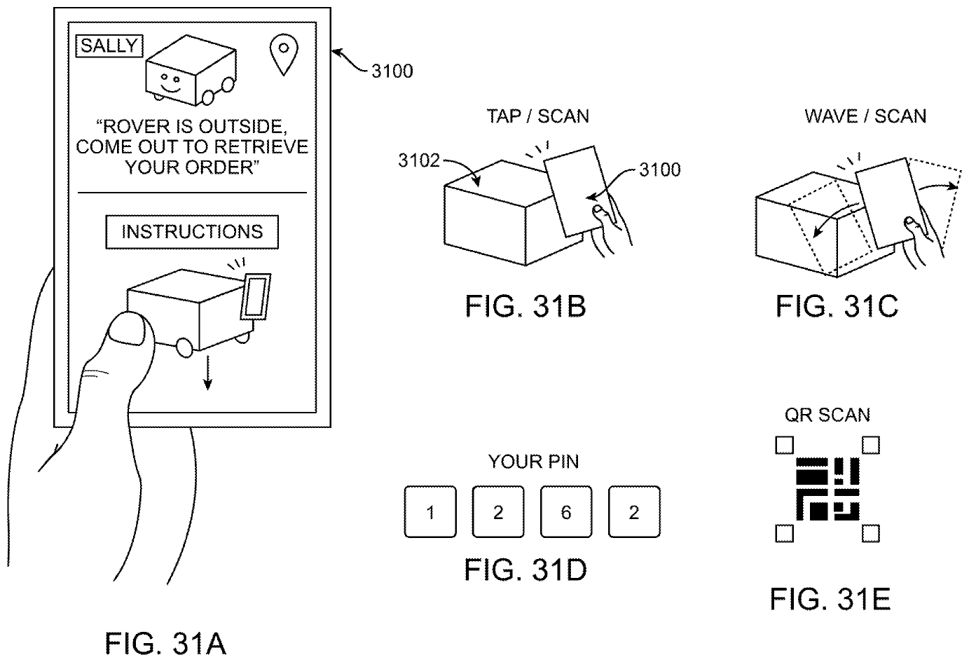

FIG. 31A-31E illustrate examples of mechanisms the delivery robot may use to communicate with a user device, in order to validate a recipient of the robot's cargo. FIG. 31A illustrates one example of a graphical display that can be shown on the user device 3100, to communicate to the operator of the device that the robot has arrived. The graphical display can also communicate instructions for how to notify the robot that the operator is the intended recipient of the robot's cargo.

FIG. 31B illustrates one mechanism for indicating to the robot that the robot has reached the recipient. In this example, the user device 3100 uses a near field communication system, and by tapping the user device 3100 on the robot 3102, identification information can be communicated from the user device 3100 to the robot 3102. FIG. 31C illustrates another example of a near field communication system. In this example, identification information can be communicated from the user device 3100 to the robot 3102 by waving the user device 3100 in the vicinity of the robot 3102.

FIG. 31D illustrates another mechanism for communicating identification information from the user device 3100 to the robot. In this example, the robot may request a personal identification number, which the recipient may be able to enter into an interface on the robot, or into a screen on the user device 3100.

FIG. 31E illustrates another mechanism by which the robot can identify a person. In this example, a Quick Response (QR) code is used to validate the recipient. In some examples, the robot can display the QR code, and the recipient can scan the QR code with the user device 3100. In some examples, the user device 3100 can display the QR code, to be scanned by the robot.

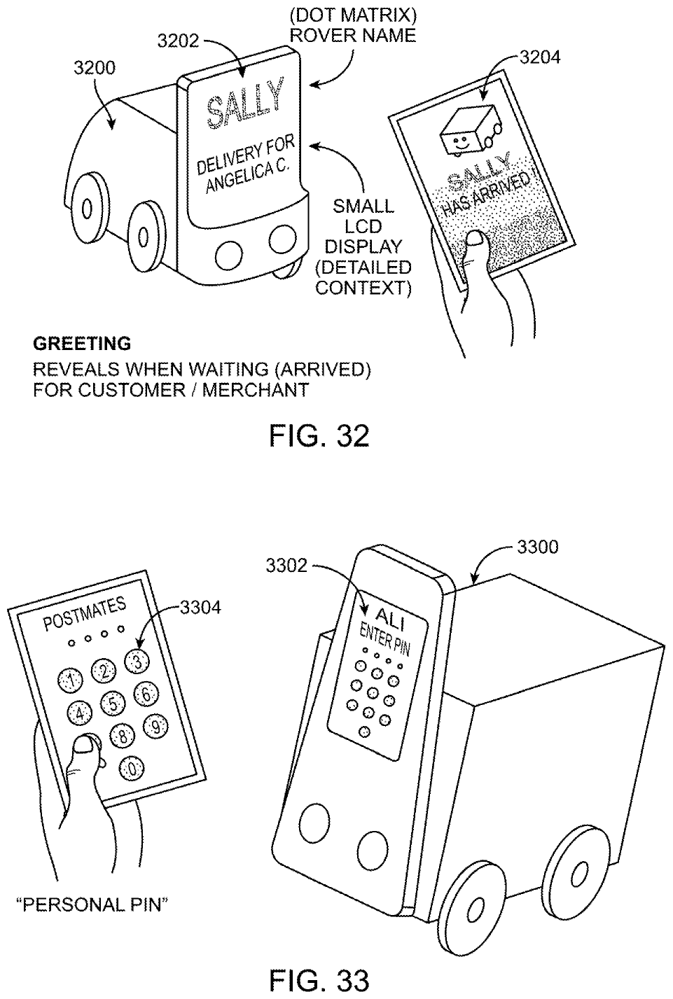

FIG. 32 illustrates an example of an interaction between the robot 3200 and the user device 3204, to indicate to a person that the robot is delivering items for the person. In some examples, the robot 3200 may include a front-facing display device 3202, with which the robot 3200 can display a name or label associated with the robot (e.g., “Sally”). In this example, the robot's name can also appear on the person's user device 3204, to inform the person that the robot 3200 is looking for him or her. If the robot 3200 is displaying another name, or another name appears on the user device 3204, the person can recognize that the robot 3200 is looking for someone else. In various examples, the robot 3200 can also display the person's name or a user identifier associated with the person, to further assist the person in recognizing that the robot is looking for him or her. In various examples, the robot's display device 3202 can include a combination of display elements. For example, the display device 3202 can include an LED array for displaying simple graphics and/or text. As a further example, the display can include an LCD panel for displaying more complex text and/or graphics. In some embodiments, the display device 3202 may be a touch screen for receiving input from the user (e.g. recipient).

FIGS. 33 illustrates another example of a mechanism by which a person can verify himself or herself to the robot 3300 as the recipient for the robot's cargo. In this example, an application on a person's smartphone or other user device 3304 can display a number pad, with which the person can enter a personal identification number. The application can send the personal identification number to the robot 3300 using a short-distance communication protocol, such as Bluetooth®. Alternatively or additionally, the robot 3300 may have touchscreen 3302, through which the person can enter the personal identification number.

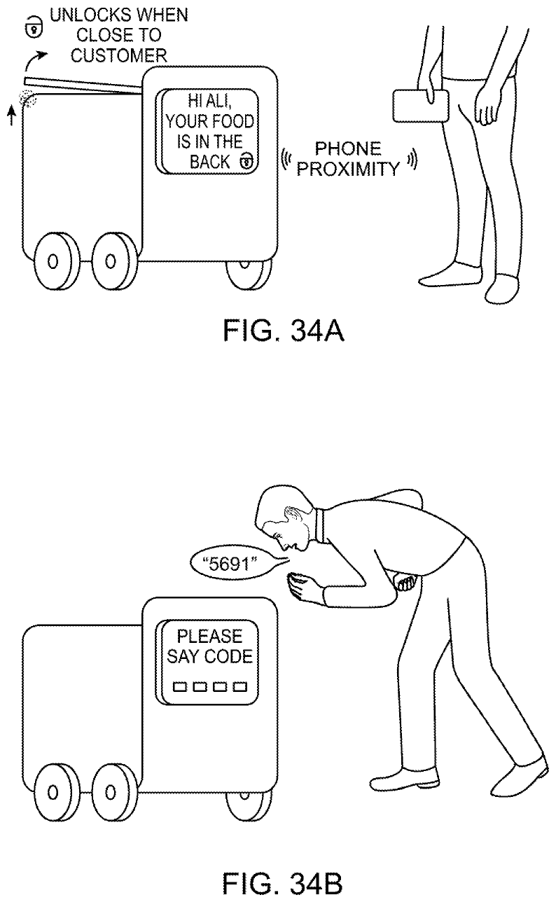

FIGS. 34A-34B illustrate additional mechanisms by which the robot can validate a person as the intended recipient. As illustrated in FIG. 34A, the robot may be able to identify a smartphone or other user device using NFC, Bluetooth®, Wi-Fi, or another form of wireless communication, or from GPS tracking of the robot and the user device. In this and other examples, when the robot detects that the robot is within a certain distance of the user device (e.g., two or three feet, or another distance), the robot can send a signal that triggers an alert on the user device (e.g., the user device may chime or vibrate), and/or that causes the user device to receive a message (e.g., an email or a text message, for example). The robot can also display to the person a message indicate that the robot has items for the person. In some examples, the robot can also unlock and/or open the hatch or lid to the cargo area. As illustrated in FIG. 34B, the robot may request that the person verbalize an access code, before the robot unlocks the cargo area.

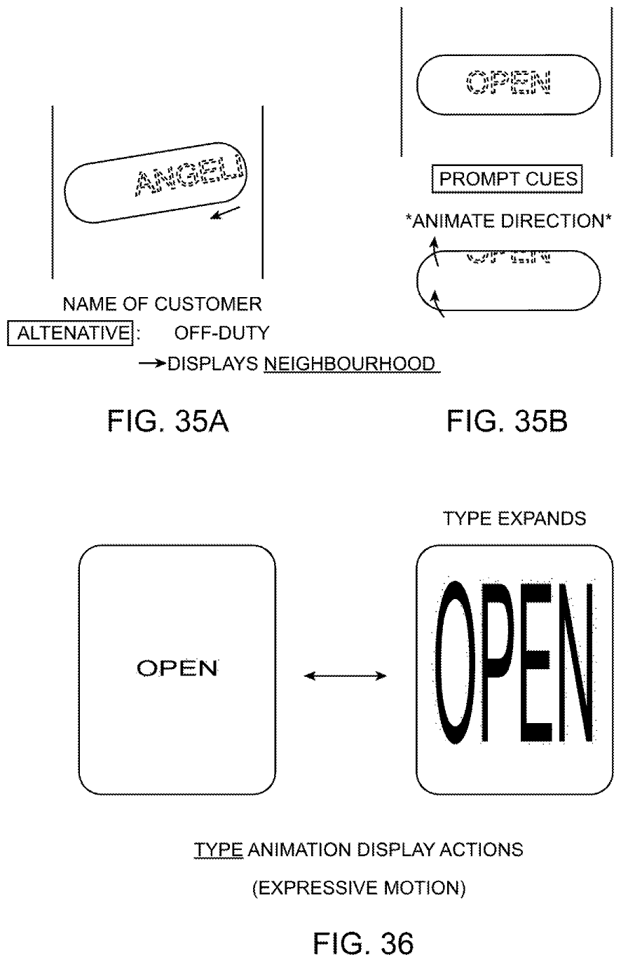

FIGS. 35A-35B illustrate examples of messages that the robot may be able to display with a simple array of LEDs or other light sources when interacting with a delivery recipient. In FIG. 35A, the robot is illustrated as displaying a recipient's name. The robot can, for example, cause the text to scroll or slide into view. In other examples, the robot can display the text “Off Duty” when the robot is not in the process of making a delivery. In FIG. 35B, the robot is displaying the text “Open,” as a prompt for a person to open to cargo area. The text may be animated; for example, the text may slide or scroll up, to further indicate what it is the robot is directing the person to do.

FIG. 36 illustrates another example of dynamic text that the robot can use to prompt a recipient to open the robot's cargo door. In this example, the robot can use a display screen to display the word “OPEN,” and can enlarge the letters. The letters can then shrink back to the first size, or can disappear and be redisplayed in the first size. The animation can then repeat until the robot's detects that the cargo door has been opened.

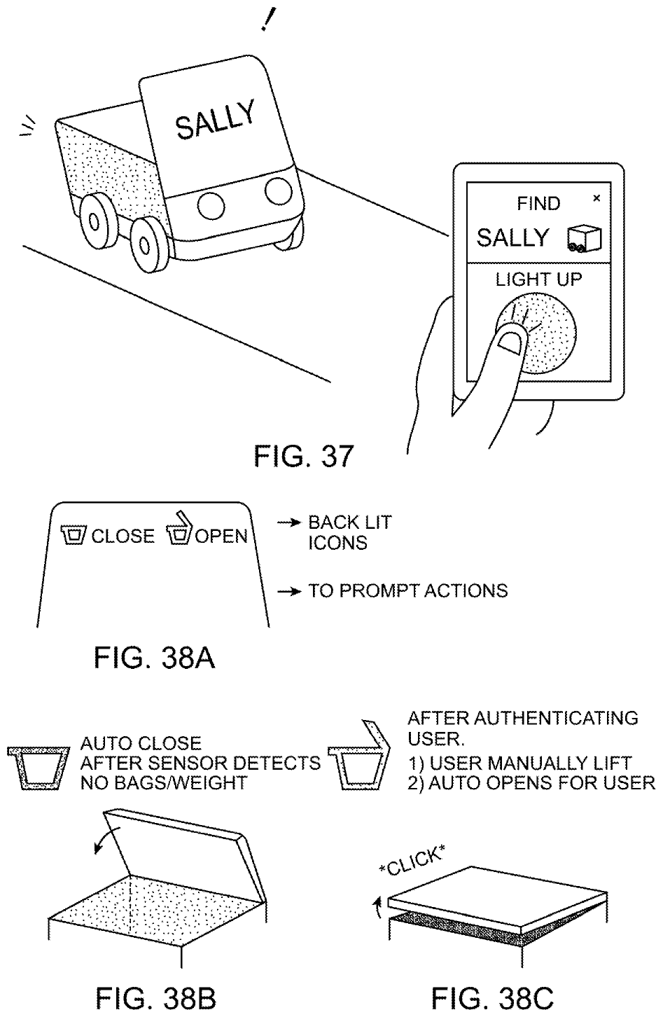

FIG. 37 illustrates an example of an interaction a person can have with a robot when the person is expecting a delivery. In this example, the person may be able to view the robot's status through an application executing on a smartphone or other user device. The application may provide graphical elements that the operator of the user device can use to locate the robot. For example, the application can display the robot's name, which the robot may also be displaying. As another example, the application can include a button that, when activated, can cause lighting elements on the robot to activate. In this example, the button may be a particular color, or the person may be able to select a color. The robot's lighting system may light up in a similar color, to help the person to identify the robot.

FIGS. 38A-38C illustrate examples of icons the robot can activate or display. In these examples, the icons can displayed using back-lit cut-outs, or can be formed using an LCD or LED display. In these examples, the icons can indicate actions that a recipient should take, or an action that the robot is performing. For example, as illustrated in FIG. 38B, the robot can use an icon to indicate that the robot is closing the cargo hatch. In some examples, the robot may be able to detect that items have been removed from the cargo area, for example using pressure or motion sensors. After waiting a few seconds, the robot may then be able to close the cargo hatch. FIG. 38C illustrates an icon that the robot can use to indicate that the recipient should open the cargo hatch. The robot may unlock the hatch once the recipient has been validated, and then indicate, with the icon, that the hatch is ready to be opened.

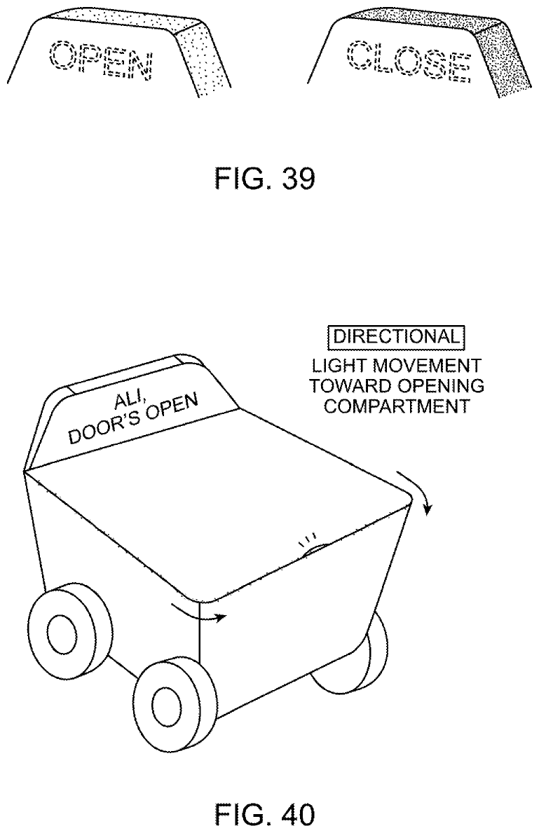

In various examples, the robot can use lighting elements in conjunction with textual displays, to prompt a recipient and/or to indicate the robot's actions. For example, as illustrated in FIG. 39, the robot can display the word “OPEN” and at the same time illuminate a lighting element in green, to indicate that the recipient can open the cargo door. As another example, the robot can display the word “CLOSE” and illuminate the lighting element in red to indicate that the recipient should close the cargo door. Alternatively, the red light can indicate to the recipient that the robot is about to automatically close the door.

In various examples, the robot can use lighting elements to assist the recipient in figuring out how to open the cargo hatch. For example, as illustrated in FIG. 40, the robot can include a track of lights (such as LEDs) along the edge of the hatch, which the robot can light sequentially in the direction of the hatch's handle, starting near the back of the hatch. By lighting the track of lights sequentially, the lights appear to be moving towards the handle.

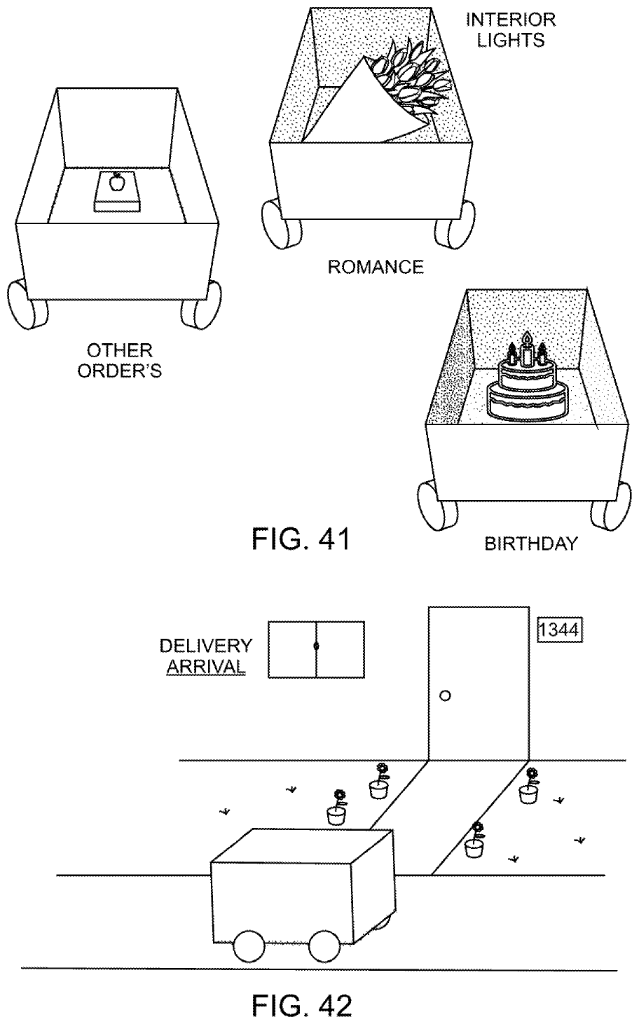

FIG. 41 illustrates examples of interior lights that the robot can activate when the robot's cargo area is opened by a recipient. The robot can be equipped with lights that can be activated in different colors. For example, the robot can turn the lights on in red when delivering flowers, in multiple colors when delivering birthday gifts, or in green when delivering other items. The color can be selected at the time the robot is programmed to make the delivery or before the robot arrives at its destination.

In various examples, as illustrated in FIG. 42, the robot can also include underglow or ground effect lighting. This type of lighting is mounted to the underside of the robot, and, when activated, casts a light on the ground underneath and in the immediate area of the robot. In various examples, the robot can change the color emitting by the ground effect lighting to indicate the robot's current status. For example, the robot can activate a green color when the robot reaches its destination, or a red color when the robot is stopped or stopping.

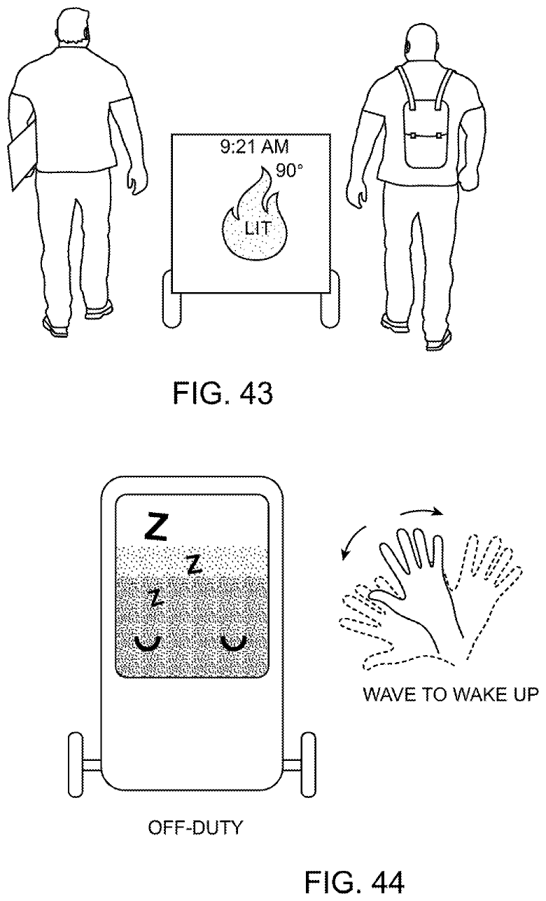

In various examples, the robot can provide information while the robot is underway. For example, as illustrated in FIG. 43, the robot can use an external display to indicate the current time and outdoor temperature, possibly with a graphical element that illustrates the current temperature. The robot may be able to receive up-to-date local information using a connection with a cellular or a Wi-Fi network.

In various examples, the robot can include gesture sensors and/or gesture programming, so that the robot can react to hand motions made by people. For example, as illustrated in FIG. 44, the robot may be able to detect a hand waving motion. When the robot is idle, the robot may interpret the hand waving motion as an indication to activate. In the example of FIG. 44, the robot displays a cartoon of a sleeping face to indicate that the robot is inactive.

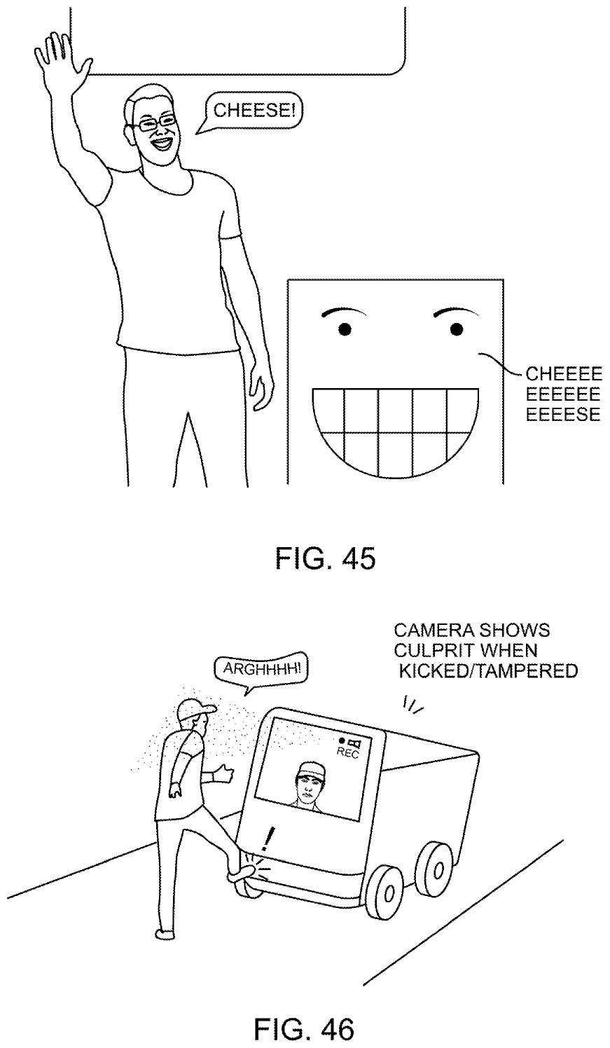

In various examples, the robot can be programmed to interact with people in a friendly manner. Doing so can encourage people to see the robot as helpful and non-threatening. For example, as illustrated in FIG. 45, the robot can include natural language processing, or may be able to communicate over a wireless network with a natural language processing system. The robot can thus respond to a person's request to take the robot's photos with a display of a smiling face. Alternatively or additionally, the robot may be programmed to respond to a person's physical presence in front of the robot, and/or the verbal command “cheese” as an indication that a photograph is about to be taken.

In various examples, the robot may need to respond to abuse. For example, as illustrated in FIG. 46, a person may tamper with or physically strike the robot. In this and other examples, as a security measure, the robot can activate a camera when the robot sense a contact that is more forceful than a threshold amount (e.g., so that casual bumping is not registers as abuse). As another example, the robot can activate the camera when the robot senses an attempt to forcefully open the cargo area. The camera can record the person who is perpetrating the abuse. In some examples, the robot can also display the recoded image, so that the person is aware that he or she is being recorded. This may encourage the person to cease the abuse. In a similar manner, the robot may activate the cameras when one or more of the plurality of sensors indicate an attempt to open the door enclosing the cargo area.

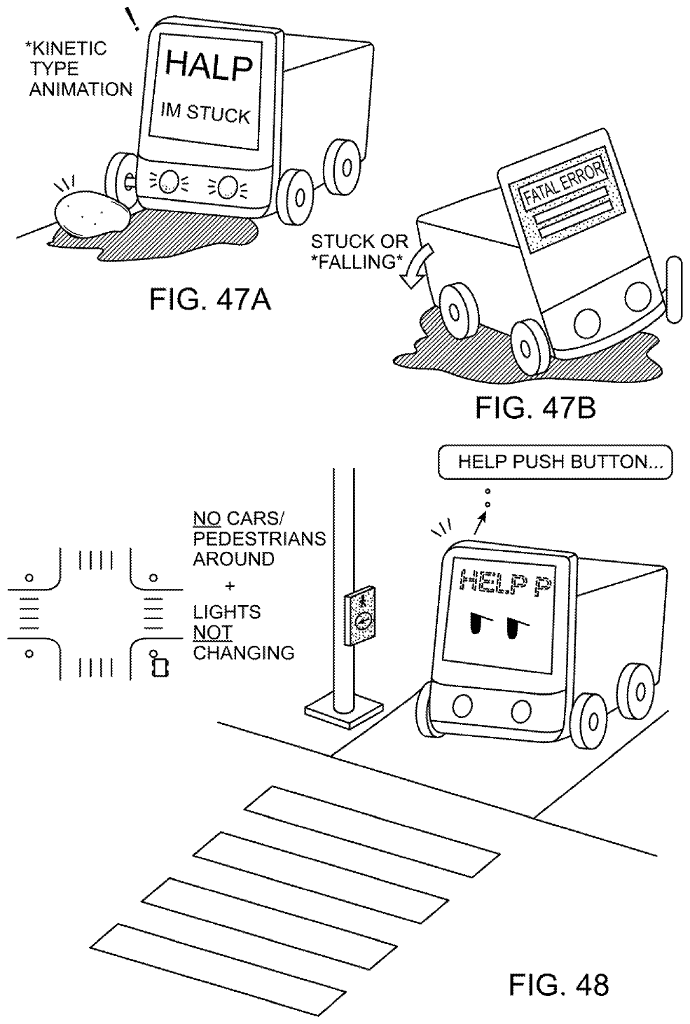

There may be instances when the robot needs physical help from a passerby. The robot can use various mechanisms to signal a need for help. FIGS. 47A-47B illustrates images and text the robot can display on a display screen. In FIG. 47A, the robot has run into an obstacle and one wheel has become stuck. To indicate this condition, the robot can print “HELP I'M STUCK” on the front display screen. In some examples, the robot can also flash the robot's front lights. In FIG. 47B, the robot may have become stuck, may have fallen over, may have suffered a serious mechanical failure, and/or may have suffered a serious software error that has rendered the robot incapable of continuing. In this example, the robot can display “FATAL ERROR” on the front display screen.

In the example of FIG. 48, the robot has reached a street crossing. The robot cannot cross until the signal light indicates that the robot can cross, but it may be that the signal lights are configured to respond to the presence of cars at the intersection, or when a person pushes a crosswalk button. When no cars have driven by for a while, the robot may thus be stuck waiting for the light to change. In this situation, the robot can signal a need for a person to push the crosswalk button. For example, the robot can display a graphic of eyes looking in the direction of the crosswalk button, along with the words “HELP PUSH BUTTON,” which may scroll across the robot's screen.

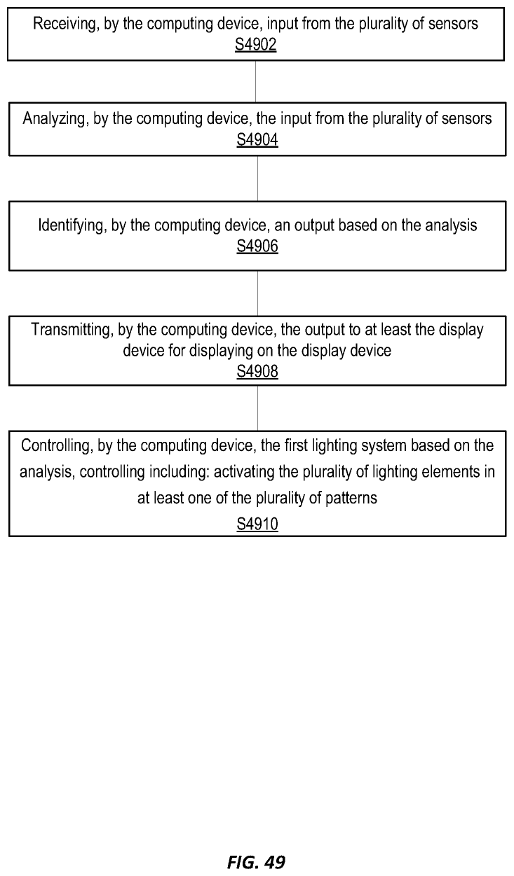

FIG. 49 illustrates an exemplary flowchart of steps for moving physical items in open spaces and controlling a delivery robot to output to interact with humans (e.g. a user and/or passerby), according to various embodiments. The delivery robot may include a chassis, a set of wheels coupled to the chassis, a motor operable to drive the set of wheels, a body mounted to the chassis, the body including a cargo area, a first lighting system, a display device mounted on an exterior of the robot, a plurality of sensors, and a computing device. At step S4902, the computing device of the delivery robot may receive sensory input from the plurality of sensors. For example, the computer may receive image input from onboard cameras, sound input (e.g. car honking, dog barking, or human yelling), temperature input etc. At step S4904, the computing device may analyze the input from the plurality of sensor. In some embodiments, the computing device may analyze the input onboard the delivery robot. In other embodiments, the computing device may transmit the sensory input to a remote computer for analysis.

At step S4906, the computing device may identify an output based on the analysis. The output may be in the form of an expression or a reaction to the sensory data about the environment surrounding the delivery robot. In some embodiments, the analysis may be performed using a machine learning algorithm, and the output may be identified among a predetermined set of output. The output may include various components such as a visual output, an audio output and a mobile output.

At step S4908, the computing device may transmit the output to at least the display device for displaying on the display device. The output may have a visual (e.g. graphic or text) component that can be displayed on the display device, and the display device may be configured to display the output received from the computing device.

At step S4910, the computing device may also control the first lighting system based on the analysis. That is, the computing device may activate the plurality of lighting elements of the first lighting system in at least one of the plurality of patterns, such as those illustrated in FIG. 9B.

Specific details were given in the preceding description to provide a thorough understanding of various implementations of systems and components for a light projection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for a delivery robot.

1. A delivery robot, comprising:
a chassis;
a set of wheels coupled to the chassis;
a motor operable to drive the set of wheels;
a body mounted to the chassis, the body including a cargo area;
a first lighting system including a plurality of lighting elements that can be activated in a plurality of patterns to indicate one or more of a direction of travel of the delivery robot or a current status of the delivery robot;
a display device mounted on an exterior of the robot;
a plurality of sensors; and
a computing device comprising a processor and a memory coupled to and readable by the processor, the memory including instructions that, when executed by the processor, cause the processor to:
receive input from the plurality of sensors,
analyze the input from the plurality of sensors,
identify an output based on the analysis,
transmit the output to at least the display device for displaying on the display device, and
control the first lighting system based on the analysis including activating the plurality of lighting elements in at least one of the plurality of patterns;
wherein the display device is configured to display the output received from the computing device.

2. The delivery robot of claim 1, wherein the plurality of lighting elements includes one or more circular elements aligned along a horizontal axis, wherein each circular element is divided in half along the horizontal axis into two individually controllable arcs.

3. The delivery robot of claim 2, wherein activating the plurality of lighting elements include includes:
activating a first individually controllable arc independently from a second individually controllable arc to create a human-line facial expression.

4. The delivery robot of claim 1, further comprising:
a second lighting system mounted to a back of the delivery robot and configured to activate when the delivery robot is stopping or stopped.

5. The delivery robot of claim 1, wherein the input from the plurality of sensors identifies stationary or moving objects around the delivery robot.

6. The delivery robot of claim 1, wherein the delivery robot has an autonomous mode and a remote controlled mode, and wherein the memory further includes instructions that, when executed by the processor, cause the processor to:
operate the delivery robot in one of the autonomous mode or the remote controlled mode,
wherein operation in the autonomous mode includes generating instructions to direct the delivery robot to move from a first location to a second location, and
wherein operation in the remote controlled mode includes receiving instructions from a remote server to direct the delivery robot to move from the first location to the second location.

7. The delivery robot of claim 1, wherein the output includes a text or an image that indicates one or more of the current status of the delivery robot, the direction of travel of the delivery robot, an identification of the delivery robot to a recipient of cargo being carried by the delivery robot, or a graphical representation of an object detected around the delivery robot.

8. The delivery robot of claim 1, wherein the output further includes motion instructions transmitted to the set of wheels, wherein the set of wheels is adapted to move based on the motion instructions received from the computing device.

9. The delivery robot of claim 1, further comprising:
one or more antennas operable to communicate with a wireless network.

10. The delivery robot of claim 1, wherein the computing device transmits a message to a user device when the computing device determines that the delivery robot has arrived at a destination.

11. The delivery robot of claim 1, further comprising:
a door enclosing the cargo area; and
a locking mechanism configured to secure the door in a closed position and coupled to the computing device, wherein the computing device is operable to operate the locking mechanism.

12. The delivery robot of claim 10, the memory further including instructions for:
validating a recipient of cargo being carried by the delivery robot before the computing device activates the locking mechanism to unlock the door;
opening the door upon validating the recipient of the cargo being carried in the cargo area; and
closing the door upon determining, using one or more of the plurality of sensors, that the cargo has been removed from the cargo area.

13. The delivery robot of claim 1, wherein the plurality of sensors includes one or more cameras operable to capture a view in a front direction, a side direction, or a back direction of the delivery robot.

14. The delivery robot of claim 13, wherein the computing device transmits data from the one or more cameras over a wireless network.

15. The delivery robot of claim 13, wherein the computing device activates the one or more cameras when one or more of the plurality of sensors indicate contact with the delivery robot having a force that is greater than a threshold.

16. The delivery robot of claim 13, wherein the computing device activates the one or more cameras when one or more of the plurality of sensors indicate an attempt to open a door enclosing the cargo area.

17. The delivery robot of claim 1, further comprising:
a set of motors including the motor, wherein a motor from the set of motors drives each wheel from the set of wheels.

18. A method of operating a delivery robot to move physical items in open spaces, the delivery robot including a chassis, a set of wheels coupled to the chassis, a motor operable to drive the set of wheels, a body mounted to the chassis, the body including a cargo area, a first lighting system including a plurality of lighting elements that can be activated in a plurality of patterns to indicate one or more of a direction of travel of the delivery robot or a current status of the delivery robot, a display device mounted on an exterior of the robot, a plurality of sensors, and a computing device, the method comprising:
receiving, by the computing device, input from the plurality of sensors;
analyzing, by the computing device, the input from the plurality of sensors;
identifying, by the computing device, an output based on the analysis;
transmitting, by the computing device, the output to at least the display device for displaying on the display device; and
controlling, by the computing device, the first lighting system based on the analysis including activating the plurality of lighting elements in at least one of the plurality of patterns,
wherein the display device is configured to display the output received from the computing device.

19. The method of claim 18, further comprising:
receiving, by the computing device, instructions from a remote server to operate the delivery robot in a remote controlled mode to move from a first location to a second location.

20. The method of claim 18, further comprising:
validating a recipient of cargo being carried by the delivery robot prior to activating a locking mechanism to unlock a door enclosing the cargo area;
opening the door upon validating the recipient of the cargo being carried in the cargo area;
determining, using one or more of the plurality of sensors, that the cargo has been removed from the cargo area; and
closing the door upon determining that the cargo has been removed from the cargo area.
